(19) United States
(12) Patent Application Publication
(10) Pub. No.: US 2025/0294341 A1
(43) Pub. Date: Sep. 18, 2025

(54) TECHNIQUES FOR CAPABILITY REPORTING

(71) Applicant: QUALCOMM Incorporated, San Diego, CA (US)

(72) Inventors: Kianoush HOSSEINI, San Diego, CA (US); Peter GAAL, San Diego, CA (US); Aziz GHOLMIEH, Del Mar, CA (US); Lei XIAO, San Jose, CA (US); Hari SANKAR, San Diego, CA (US); Alberto RICO ALVARINO, San Diego, CA (US); Jing JIANG, San Diego, CA (US)

(21) Appl. No.: 18/608,408

(22) Filed: Mar. 18, 2024

(51) Int. Cl. H04W 8/22; H04L 5/00; H04W 24/02

(52) U.S. Cl. CPC H04W 8/22; H04L 5/0092; H04W 24/02

(57) ABSTRACT

Methods, systems, and devices for wireless communications are described. In some cases, a user equipment (UE) may receive, from a network entity, a capability query requesting one or more UE capabilities associated with a set of candidate UE configurations. As such, the UE may transmit, in response to the capability query, a capability message indicating at least a subset of the one or more UE capabilities associated with the set of candidate UE configurations. Thus, the UE may receive, a control message indicating configuration information associated with at least one candidate UE configuration from the set of candidate UE configurations based on the capability message, such that the UE may communicate with the network entity in accordance with the configuration information.

### FIELD OF TECHNOLOGY

The following relates to wireless communications, including techniques for capability reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for capability reporting. In some examples, the capability reporting techniques described herein are configured for or otherwise support 6th generation (6G) communications. Generally, the techniques described herein may enable a user equipment (UE) to improve resource utilization and reduce latency associated with capability reporting. For example, a UE may receive, from a network entity, a capability query requesting one or more UE capabilities associated with a set of candidate UE configurations. As such, the UE may transmit, in response to the capability query, a capability message indicating at least a subset of the one or more UE capabilities associated with the set of candidate UE configurations. Thus, the UE may receive a control message indicating configuration information associated with at least one candidate UE configuration from the set of candidate UE configurations based on the capability message, such that the UE may communicate with the network entity in accordance with the configuration information.

Additionally, or alternatively, the UE may transmit, to the network entity, a first capability message indicating a set of threshold processing power capabilities of the UE for performing UE operations. Additionally, the UE may transmit, to the network entity, a second capability message indicating a set of candidate UE operations, processing powers associated with performing the set of candidate UE operations, a reference configuration defining one or more operational parameters for each candidate UE operation of the set of candidate UE operations, and a scaling factor indicating a change in the processing powers associated with performing the set of candidate UE operations relative to a change in the one or more operational parameters. As such, the UE may receive, from the network entity, a control message (e.g., radio resource control (RRC) message) indicating configuration information associated with one or more candidate UE operations of the set of candidate UE operations, where a summation of processing powers associated with the one or more candidate UE operations is less than or equal to the set of threshold processing power capabilities of the UE. As such, the UE may communicate with the network entity in accordance with the configuration information.

A method for wireless communications by a UE is described. The method may include receiving, from a network entity, a capability query requesting one or more UE capabilities associated with a set of candidate UE configurations, transmitting, in response to the capability query, a capability message indicating at least a subset of the one or more UE capabilities associated with the set of candidate UE configurations, receiving, from the network entity, a control message indicating configuration information associated with at least one candidate UE configuration from the set of candidate UE configurations, and communicating with the network entity in accordance with the configuration information.

A UE for wireless communications is described. The UE may include one or more memories storing processor executable code, and one or more processors coupled with the one or more memories. The one or more processors may individually or collectively be operable to execute the code to cause the UE to receive, from a network entity, a capability query requesting one or more UE capabilities associated with a set of candidate UE configurations, transmit, in response to the capability query, a capability message indicating at least a subset of the one or more UE capabilities associated with the set of candidate UE configurations, receive, from the network entity, a control message indicating configuration information associated with at least one candidate UE configuration from the set of candidate UE configurations, and communicate with the network entity in accordance with the configuration information.

Another UE for wireless communications is described. The UE may include means for receiving, from a network entity, a capability query requesting one or more UE capabilities associated with a set of candidate UE configurations, means for transmitting, in response to the capability query, a capability message indicating at least a subset of the one or more UE capabilities associated with the set of candidate UE configurations, means for receiving, from the network entity, a control message indicating configuration information associated with at least one candidate UE configuration from the set of candidate UE configurations, and means for communicating with the network entity in accordance with the configuration information.

A non-transitory computer-readable medium storing code for wireless communications is described. The code may include instructions executable by one or more processors to receive, from a network entity, a capability query requesting one or more UE capabilities associated with a set of candidate UE configurations, transmit, in response to the capability query, a capability message indicating at least a subset of the one or more UE capabilities associated with the set of candidate UE configurations, receive, from the network entity, a control message indicating configuration information associated with at least one candidate UE configuration from the set of candidate UE configurations, and communicate with the network entity in accordance with the configuration information.

Some examples of the method, UEs, and non-transitory computer-readable medium described herein may further include operations, features, means, or instructions for transmitting, in response to a second capability query received prior to the capability query, a second capability message indicating a capability of the UE to respond to the capability query, where receiving the capability query may be based on transmitting the second capability message.

In some examples of the method, UEs, and non-transitory computer-readable medium described herein, the second capability message includes an indication of a threshold duration associated with responding to the capability query.

In some examples of the method, UEs, and non-transitory computer-readable medium described herein, transmitting the second capability message may include operations, features, means, or instructions for transmitting an indication of one or more second UE capabilities associated with a set of multiple candidate UE configurations including at least the set of candidate UE configurations.

In some examples of the method, UEs, and non-transitory computer-readable medium described herein, the second capability message may be transmitted during an initial access procedure with the network entity.

In some examples of the method, UEs, and non-transitory computer-readable medium described herein, each UE capability of the at least subset of the one or more UE capabilities may be associated with performing one or more UE operations in accordance with a candidate UE configuration from the set of candidate UE configurations.

Some examples of the method, UEs, and non-transitory computer-readable medium described herein may further include operations, features, means, or instructions for receiving a second capability query requesting one or more second UE capabilities associated with a second set of candidate UE configurations and transmitting, in response to the second capability query, a second capability message indicating at least a subset of the one or more second UE capabilities associated with the second set of candidate UE configurations.

In some examples of the method, UEs, and non-transitory computer-readable medium described herein, each candidate UE configuration of the set of candidate UE configurations includes an indication of one or more bands, one or more BCs, one or more BOBCs, one or more CCs, one or more BWs, one or more parameters associated with MIMO communications, a threshold quantity of layers, or any combination thereof.

Some examples of the method, UEs, and non-transitory computer-readable medium described herein may further include operations, features, means, or instructions for inputting, into a machine learning model, the set of candidate UE configurations, where transmitting the capability message indicating the at least subset of the one or more UE capabilities may be based on the machine learning model outputting the at least subset of the one or more UE capabilities.

A method for wireless communications by a network entity is described. The method may include outputting, to a UE, a capability query requesting one or more UE capabilities associated with a set of candidate UE configurations, obtaining, in response to the capability query, a capability message indicating at least a subset of the one or more UE capabilities associated with the set of candidate UE configurations, outputting a control message indicating configuration information associated with at least one candidate UE configuration from the set of candidate UE configurations, and communicating with the UE in accordance with the configuration information.

A network entity for wireless communications is described. The network entity may include one or more memories storing processor executable code, and one or more processors coupled with the one or more memories. The one or more processors may individually or collectively be operable to execute the code to cause the network entity to output, to a UE, a capability query requesting one or more UE capabilities associated with a set of candidate UE configurations, obtain, in response to the capability query, a capability message indicating at least a subset of the one or more UE capabilities associated with the set of candidate UE configurations, output a control message indicating configuration information associated with at least one candidate UE configuration from the set of candidate UE configurations, and communicate with the UE in accordance with the configuration information.

Another network entity for wireless communications is described. The network entity may include means for outputting, to a UE, a capability query requesting one or more UE capabilities associated with a set of candidate UE configurations, means for obtaining, in response to the capability query, a capability message indicating at least a subset of the one or more UE capabilities associated with the set of candidate UE configurations, means for outputting a control message indicating configuration information associated with at least one candidate UE configuration from the set of candidate UE configurations, and means for communicating with the UE in accordance with the configuration information.

A non-transitory computer-readable medium storing code for wireless communications is described. The code may include instructions executable by one or more processors to output, to a UE, a capability query requesting one or more UE capabilities associated with a set of candidate UE configurations, obtain, in response to the capability query, a capability message indicating at least a subset of the one or more UE capabilities associated with the set of candidate UE configurations, output a control message indicating configuration information associated with at least one candidate UE configuration from the set of candidate UE configurations, and communicate with the UE in accordance with the configuration information.

Some examples of the method, network entities, and non-transitory computer-readable medium described herein may further include operations, features, means, or instructions for obtaining, in response to a second capability query output prior to the capability query, a second capability message indicating a capability of the UE to respond to the capability query, where obtaining the capability query may be based on outputting the second capability message.

In some examples of the method, network entities, and non-transitory computer-readable medium described herein, the second capability message includes an indication of a threshold duration associated with responding to the capability query.

In some examples of the method, network entities, and non-transitory computer-readable medium described herein, obtaining the second capability message may include operations, features, means, or instructions for obtaining an indication of one or more second UE capabilities associated with a set of multiple candidate UE configurations including at least the set of candidate UE configurations.

In some examples of the method, network entities, and non-transitory computer-readable medium described herein, the second capability message may be obtained during an initial access procedure with the UE.

In some examples of the method, network entities, and non-transitory computer-readable medium described herein, each UE capability of the at least subset of the one or more UE capabilities may be associated with performing one or more UE operations in accordance with a candidate UE configuration from the set of candidate UE configurations.

Some examples of the method, network entities, and non-transitory computer-readable medium described herein may further include operations, features, means, or instructions for outputting a second capability query requesting one or more second UE capabilities associated with a second set of candidate UE configurations and obtaining, in response to the second capability query, a second capability message indicating at least a subset of the one or more second UE capabilities associated with the second set of candidate UE configurations.

In some examples of the method, network entities, and non-transitory computer-readable medium described herein, each candidate UE configuration of the set of candidate UE configurations includes an indication of one or more bands, one or more BCs, one or more BOBCs, one or more CCs, one or more BWs, one or more parameters associated with MIMO communications, a threshold quantity of layers, or any combination thereof.

A method for wireless communications by a UE is described. The method may include transmitting, to a network entity, a first capability message indicating a set of threshold processing power capabilities of the UE for performing UE operations, transmitting, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters, receiving, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE, and communicating with the network entity in accordance with the configuration information.

A UE for wireless communications is described. The UE may include one or more memories storing processor executable code, and one or more processors coupled with the one or more memories. The one or more processors may individually or collectively be operable to execute the code to cause the UE to transmit, to a network entity, a first capability message indicating a set of threshold processing power capabilities of the UE for performing UE operations, transmit, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters, receive, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE, and communicate with the network entity in accordance with the configuration information.

Another UE for wireless communications is described. The UE may include means for transmitting, to a network entity, a first capability message indicating a set of threshold processing power capabilities of the UE for performing UE operations, means for transmitting, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters, means for receiving, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE, and means for communicating with the network entity in accordance with the configuration information.

A non-transitory computer-readable medium storing code for wireless communications is described. The code may include instructions executable by one or more processors to transmit, to a network entity, a first capability message indicating a set of threshold processing power capabilities of the UE for performing UE operations, transmit, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters, receive, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE, and communicate with the network entity in accordance with the configuration information.

In some examples of the method, UEs, and non-transitory computer-readable medium described herein, each candidate UE operation of the set of multiple candidate UE operations includes one or more second UE operations and the set of multiple candidate UE operations may be pre-configured at the UE.

In some examples of the method, UEs, and non-transitory computer-readable medium described herein, the set of multiple candidate UE operations includes each operation supported by the UE.

In some examples of the method, UEs, and non-transitory computer-readable medium described herein, the set of threshold processing power capabilities includes one or more maximum processing power capabilities, one or more minimum processing power capabilities, or both.

In some examples of the method, UEs, and non-transitory computer-readable medium described herein, the set of threshold processing power capabilities includes a first threshold processing power capability of the UE indicating a total processing power capability of the UE and one or more second threshold processing power capabilities of the UE based on a respective frequency range from a set of multiple frequency ranges.

In some examples of the method, UEs, and non-transitory computer-readable medium described herein, the first threshold processing power capability of the UE may be based on a respective weighting factor associated with each frequency range of a set of multiple frequency ranges, where each weighting factor scales a second threshold processing power of the one or more second threshold processing power capabilities associated with a respective frequency range of the set of multiple frequency ranges relative to other frequency ranges of the set of multiple frequency ranges.

In some examples of the method, UEs, and non-transitory computer-readable medium described herein, transmitting the first capability message may include operations, features, means, or instructions for transmitting an indication of the weighting factors associated with the set of multiple frequency ranges.

In some examples of the method, UEs, and non-transitory computer-readable medium described herein, each of the one or more second threshold processing power capabilities of the UE may be further based on a band of the respective frequency range, a BC of the respective frequency range, a band of BC of the respective frequency range, or any combination thereof.

Some examples of the method, UEs, and non-transitory computer-readable medium described herein may further include operations, features, means, or instructions for transmitting an indication of one or more bands, one or more BCs, or both, supported by the UE.

In some examples of the method, UEs, and non-transitory computer-readable medium described herein, the processing powers, the scaling factor, or both, may be based on a frequency range associated with the reference configuration, a band associated with the reference configuration, or both.

In some examples of the method, UEs, and non-transitory computer-readable medium described herein, the set of threshold processing power capabilities may be based on a type of the UE, a category of the UE, or both.

In some examples of the method, UEs, and non-transitory computer-readable medium described herein, the set of threshold processing power capabilities may be based on a cell group.

In some examples of the method, UEs, and non-transitory computer-readable medium described herein, the one or more operational parameters includes a band, a BC, a band of BC, a BW, a subcarrier spacing, a frequency, a quantity of layers, or any combination thereof.

In some examples of the method, UEs, and non-transitory computer-readable medium described herein, transmitting the second capability message may include operations, features, means, or instructions for transmitting a matrix indicating the set of multiple candidate UE operations, the processing powers associated with performing the set of multiple candidate UE operations, the reference configuration, and the scaling factor.

In some examples of the method, UEs, and non-transitory computer-readable medium described herein, each of the first capability message and the second capability message may be transmitted in response to a respective capability request.

A method for wireless communications by a network entity is described. The method may include obtaining, from a UE, a first capability message indicating a set of threshold processing power capabilities of the UE for performing UE operations, obtaining, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters, outputting, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE, and communicating with the UE in accordance with the configuration information.

A network entity for wireless communications is described. The network entity may include one or more memories storing processor executable code, and one or more processors coupled with the one or more memories. The one or more processors may individually or collectively be operable to execute the code to cause the network entity to obtain, from a UE, a first capability message indicating a set of threshold processing power capabilities of the UE for performing UE operations, obtain, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters, output, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE, and communicate with the UE in accordance with the configuration information.

Another network entity for wireless communications is described. The network entity may include means for obtaining, from a UE, a first capability message indicating a set of threshold processing power capabilities of the UE for performing UE operations, means for obtaining, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters, means for outputting, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE, and means for communicating with the UE in accordance with the configuration information.

A non-transitory computer-readable medium storing code for wireless communications is described. The code may include instructions executable by one or more processors to obtain, from a UE, a first capability message indicating a set of threshold processing power capabilities of the UE for performing UE operations, obtain, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters, output, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE, and communicate with the UE in accordance with the configuration information.

In some examples of the method, network entities, and non-transitory computer-readable medium described herein, each candidate UE operation of the set of multiple candidate UE operations includes one or more second UE operations and the set of multiple candidate UE operations may be pre-configured at the UE.

In some examples of the method, network entities, and non-transitory computer-readable medium described herein, the set of multiple candidate UE operations includes each operation supported by the UE.

In some examples of the method, network entities, and non-transitory computer-readable medium described herein, the set of threshold processing power capabilities includes one or more maximum processing power capabilities, one or more minimum processing power capabilities, or both.

In some examples of the method, network entities, and non-transitory computer-readable medium described herein, the set of threshold processing power capabilities includes a first threshold processing power capability of the UE indicating a total processing power capability of the UE and one or more second threshold processing power capabilities of the UE based on a respective frequency range from a set of multiple frequency ranges.

In some examples of the method, network entities, and non-transitory computer-readable medium described herein, the second threshold processing power capability of the UE may be based on a respective weighting factor associated with each frequency range of a set of multiple frequency ranges, where each weighting factor scales a second threshold processing power of the one or more second threshold processing power capabilities associated with a respective frequency range of the set of multiple frequency ranges relative to other frequency ranges of the set of multiple frequency ranges.

In some examples of the method, network entities, and non-transitory computer-readable medium described herein, obtaining the first capability message may include operations, features, means, or instructions for obtaining an indication of the weighting factors associated with the set of multiple frequency ranges.

In some examples of the method, network entities, and non-transitory computer-readable medium described herein, each of the one or more first threshold processing power capabilities of the UE may be further based on a band of the respective frequency range, a BC of the respective frequency range, a band of BC of the respective frequency range, or any combination thereof.

Some examples of the method, network entities, and non-transitory computer-readable medium described herein may further include operations, features, means, or instructions for obtaining an indication of one or more bands, one or more BCs, or both, supported by the UE.

In some examples of the method, network entities, and non-transitory computer-readable medium described herein, the processing powers, the scaling factor, or both, may be based on a frequency range associated with the reference configuration, a band associated with the reference configuration, or both.

In some examples of the method, network entities, and non-transitory computer-readable medium described herein, the set of threshold processing power capabilities may be based on a type of the UE, a category of the UE, or both.

In some examples of the method, network entities, and non-transitory computer-readable medium described herein, the set of threshold processing power capabilities may be based on a cell group.

In some examples of the method, network entities, and non-transitory computer-readable medium described herein, the one or more operational parameters includes a band, a BC, a band of BC, a BW, a subcarrier spacing, a frequency, a quantity of layers, or any combination thereof.

In some examples of the method, network entities, and non-transitory computer-readable medium described herein, obtaining the second capability message may include operations, features, means, or instructions for obtaining a matrix indicating the set of multiple candidate UE operations, the processing powers associated with performing the set of multiple candidate UE operations, the reference configuration, and the scaling factor.

In some examples of the method, network entities, and non-transitory computer-readable medium described herein, each of the first capability message and the second capability message may be obtained in response to a respective capability request output by the network entity.

### BRIEF DESCRIPTION OF THE DRAWINGS

FIG. 1 shows an example of a wireless communications system that supports techniques for capability in accordance with one or more aspects of the present disclosure.

FIG. 2 shows an example of a wireless communications system that supports techniques for capability reporting in accordance with one or more aspects of the present disclosure.

FIG. 3 shows an example of a wireless communications system that supports techniques for capability reporting in accordance with one or more aspects of the present disclosure.

FIG. 4 shows an example of a process flow that supports techniques for capability reporting in accordance with one or more aspects of the present disclosure.

FIG. 5 shows an example of a process flow that supports techniques for capability reporting in accordance with one or more aspects of the present disclosure.

FIGS. 6 and 7 show block diagrams of devices that support techniques for capability reporting in accordance with one or more aspects of the present disclosure.

FIG. 8 shows a block diagram of a communications manager that supports techniques for capability reporting in accordance with one or more aspects of the present disclosure.

FIG. 9 shows a diagram of a system including a device that supports techniques for capability reporting in accordance with one or more aspects of the present disclosure.

FIGS. 10 and 11 show block diagrams of devices that support techniques for capability reporting in accordance with one or more aspects of the present disclosure.

FIG. 12 shows a block diagram of a communications manager that supports techniques for capability reporting in accordance with one or more aspects of the present disclosure.

FIG. 13 shows a diagram of a system including a device that supports techniques for capability reporting in accordance with one or more aspects of the present disclosure.

FIGS. 14 through 17 show flowcharts illustrating methods that support techniques for capability reporting in accordance with one or more aspects of the present disclosure.

### DETAILED DESCRIPTION

In some wireless communications systems, a user equipment (UE) may support capability reporting in which the UE transmits, to a network entity, a capability message indicating one or more capabilities supported by the UE. However, conventional capability reporting may be associated with inefficient resource consumption, inefficient power usage, and increased latency, among other disadvantages. For example, in some cases, different operations (e.g., features) supported by a UE may share common parameters, however, capability definitions, capability types, and capability reporting for the different features may occur separately, resulting in inefficient resource consumption. Additionally, or alternatively, different types of capability signaling may result in a UE under-reporting capabilities of the UE (e.g., act conservatively in support of different operations), which may result in the UE refraining from allocating processing power to certain features to ensure that enough power is available for worst-case scenarios, should they occur, which may be unlikely, resulting in inefficient power usage and inefficient resource consumption. Additionally, or alternatively, due to different types of capability signaling per UE across different operations, configuration of the different UEs by the network entity may increase in complexity, thus increasing latency.

Accordingly, techniques described herein may enable a UE to improve resource utilization and reduce latency associated with capability reporting. For example, a UE may receive, from a network entity, a capability query requesting for the UE to transmit, via capability information, an indication of one or more capabilities of the UE for one or more candidate UE configurations indicated via the capability query. As such, the UE may transmit, in response to the capability query, a capability message indicating the capability information that further indicates the one or more capabilities of the UE for the one or more candidate UE configurations. Thus, the network entity may select a candidate UE configuration of the one or more candidate UE configurations based on the capability information and transmit, to the UE, configuration information indicating the selected candidate UE configuration.

Additionally, or alternatively, the UE may determine a set of processing blocks (e.g., capability blocks), where each processing block is associated with a set of operations (e.g., features, capabilities) supported by the UE and a processing power (e.g., usage cost). Additionally, the UE may support one or more processing power thresholds. As such, the UE may transmit, via one or more capability messages, an indication of the set of processing blocks, the processing powers associated with the set of processing blocks, a reference configuration associated with the processing powers, a scaling factor associated with the processing powers, and the one or more processing power thresholds, such that the network entity may configure the UE in accordance with the indicated information. That is, the network entity may select one or more processing blocks from the set of processing blocks based on a desired configuration of the UE, where a summation of the processing powers associated with the one or more selected processing blocks based on the desired configuration satisfies the one or more threshold processing powers of the UE. As such, the network entity may transmit, to the UE, configuration information associated with the one or more selected processing blocks and may communicate with the UE in accordance with the configuration information.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to techniques for capability reporting for (e.g., for 6th generation (6G) communications or for other types of communications systems).

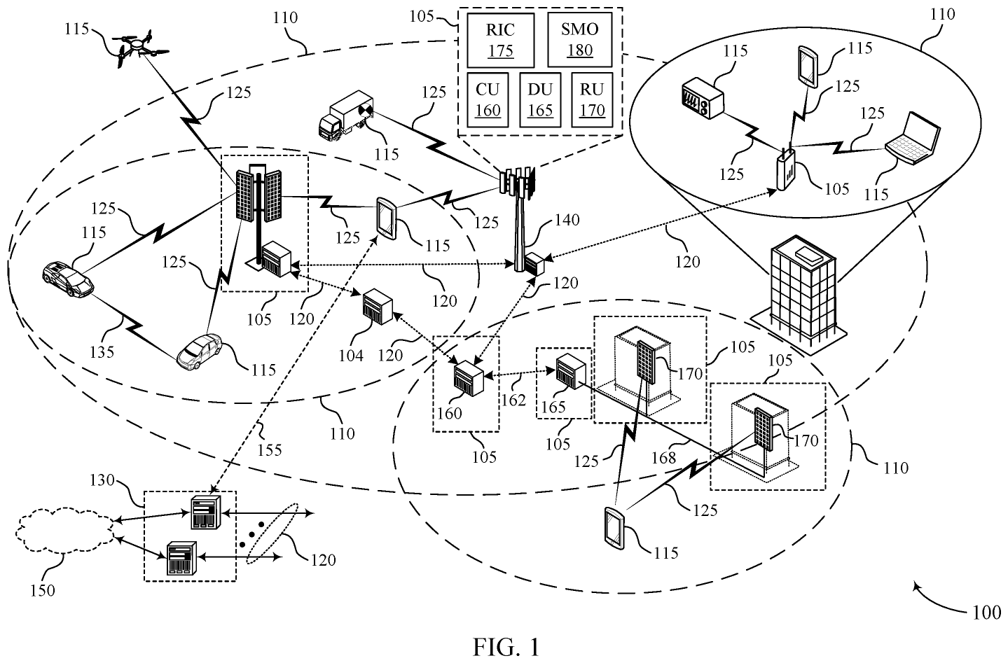

FIG. 1 shows an example of a wireless communications system 100 that supports techniques for capability reporting in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may support techniques to enable a UE 115 to improve resource utilization and reduce latency associated with capability reporting. For example, a UE 115 may receive, from a network entity 105, a capability query requesting for the UE 115 to transmit, via capability information, an indication of one or more capabilities of the UE 115 for one or more candidate UE 115 configurations indicated via the capability query. As such, the UE 115 may transmit, in response to the capability query, a capability message indicating the capability information indication the one or more capabilities of the UE 115 for the one or more candidate UE 115 configurations. Thus, the network entity 105 may select a candidate UE 115 configuration of the one or more candidate UE 115 configurations based on the capability information and transmit, to the UE 115, configuration information indicating the selected candidate UE 115 configuration.

Additionally, or alternatively, the UE 115 may determine a set of processing blocks (e.g., capability blocks), where each processing block is associated with a set of operations (e.g., features, capabilities) supported by the UE 115 and a processing power (e.g., usage cost). Additionally, the UE 115 may support one or more processing power thresholds. As such, the UE 115 may transmit, via one or more capability messages, an indication of the set of processing blocks, the processing powers associated with the set of processing blocks, a reference configuration associated with the processing powers, a scaling factor associated with the processing powers, and the one or more processing power thresholds, such that the network entity 105 may configure the UE 115 in accordance with the indicated information. That is, the network entity 105 may select one or more processing blocks from the set of processing blocks based on a desired configuration of the UE 115, where a summation of the processing powers associated with the one or more selected processing blocks based on the desired configuration satisfies the one or more threshold processing powers of the UE 115. As such, the network entity 105 may transmit, to the UE 115, configuration information associated with the one or more selected processing blocks and may communicate with the UE 115 in accordance with the configuration information.

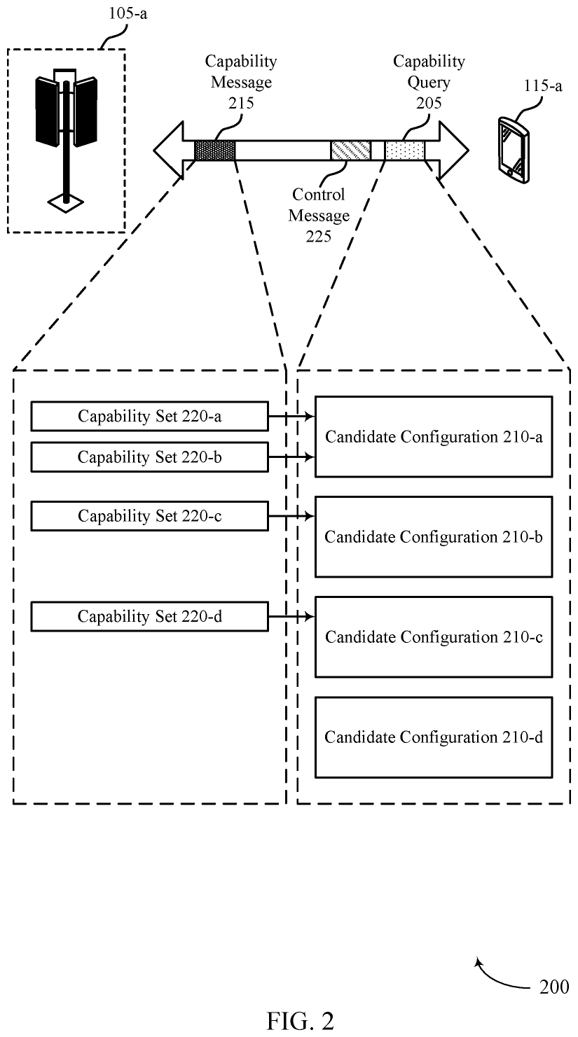

FIG. 2 shows an example of a wireless communications system 200 that supports techniques for capability reporting in accordance with one or more aspects of the present disclosure. In some cases, the wireless communications system 200 may implement or be implemented by aspects of the wireless communications system 100, which may be an example of a 5G, 6G, or other type of communications system. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, a UE 115, such as the UE 115-a, may support capability reporting in which the UE 115-a transmits, to a network entity 105, such as the network entity 105-a, a capability message 215 indicating one or more capabilities supported by the UE 115-a. However, conventional capability reporting may be associated with inefficient resource consumption, inefficient power usage, and increased latency, among other disadvantages. For example, in some cases, different features (e.g., operations, capabilities, functions) supported by the UE 115-a may share common parameters (e.g., attributes), however, capability definitions, capability types, and capability reporting for the different features may occur separately, resulting in inefficient resource consumption. For example, may features associated with multi-carrier operations, such as carrier aggregation (CA), dual connectivity (DC), multi-transmission reception points (mTRP), multi-SIM, dual-SIM dual-active (DSDA), Layer 1 (L1)/Layer 2 (L2) mobility, and multiple processing timelines on a same carrier, may share common parameters, however, capability definitions, capability types, and capability reporting for the different features associated with multi-carrier operations may occur separately.

Additionally, or alternatively, different types of capability signaling may result in a UE under-reporting capabilities of the UE 115-a (e.g., act conservatively in support of different operations), which may result in the UE 115-a refraining from allocating power to certain features to ensure that enough power is available for worst-case scenarios, should they occur, which may be unlikely, resulting in inefficient power usage and inefficient resource consumption. In other words, the UE 115-a may be associated with a threshold power usage (e.g., maximum power usage) but may operate well below (e.g., a threshold deviation below) the threshold power usage to be prepared for worst case scenarios (e.g., highest possible power consumption). For example, if a first feature (e.g., feature X) is reported per band combination (BC) or band of band combination (BOBC) and a second feature (e.g., feature Y) is reported per UE or per band, the UE 115-a may consider a worst case combination of the first feature and a second feature (e.g., greatest possible power consumption to support both features) for capability reporting.

Additionally, or alternatively, due to different types of capability signaling per UE across different features, configuration of the different UEs 115 by the network entity 105-a may increase in complexity, thus increasing latency. That is, due to the network entity 105-a supporting multiple UEs 115 with different capabilities, the network entity 105-a may reduce complexity of scheduling (e.g., simplify scheduling) by scheduling the multiple UEs 115 according to a UE 115 associated with most restrictive capabilities (e.g., out of the multiple UEs 115). As such, other UEs 115 of the multiple UEs 115 may be scheduled in a way that does not utilize a threshold power consumption capability of the other UEs 115.

Accordingly, techniques described herein may enable the wireless communications system 200 to improve resource utilization and reduce latency associated with capability reporting. For example, the UE 115-a may receive, from the network entity 105-a, a capability query 205 requesting for the UE 115-a to transmit, via capability information, an indication of one or more capabilities of the UE 115-a for one or more candidate configurations 210 indicated via the capability query 205. That is, the network entity 105-a may indicate, to the UE 115-a, one or more (e.g., a set) of potential configuration profiles for the UE 115-a, which may be referred to as candidate configurations 210, via a capability query 205. For example, the network entity 105-a may indicate, via the capability query 205, a candidate configuration 210-a, a candidate configuration 210-b, a candidate configuration 210-c, and a candidate configuration 210-d. In such cases, the candidate configurations 210 may be based on potential bands, potential BCs, potential BOBC, or any combination thereof, that the network entity 105-a may configure for the UE 115-a. Additionally, or alternatively, the candidate configurations 210 may be based on a quantity of component carriers (CCs) in each band, a bandwidth of each CC, a quantity of layers, a quantity of inputs, outputs, or both, for MIMO communications, or the like thereof.

Additionally, or alternatively, the capability query 205 (e.g., or another capability query 205) may indicate one or more ranges (e.g., boundaries) for one or more configuration parameters. That is, one or more candidate configurations 210 (e.g., indicated in the capability query 205 or a previous capability query 205) may be associated with the one or more configuration parameters, such that the capability query 205 may indicate one or more ranges of values (e.g., via indication of a minimum, a maximum, or both) for each of the one or more configuration parameters (e.g., rather than indicating specific values for each of the one or more configuration parameters).

As such, the UE 115-a may transmit, in response to the capability query 205, a capability message 215 indicating capability information further indicating one or more capabilities of the UE 115-a for the candidate configurations 210 (e.g., and the one or more ranges of values for the one or more configuration parameters associated with the candidate configurations 210). That is, the UE 115-a may provide, to the network entity 105-a, an indication of one or more capability sets 220 for the candidate configurations 210. For example, the UE 115-a may support multiple capability sets 220, such as a capability set 220-a and a capability set 220-b, for the candidate configuration 210-a. In such cases, the capability set 220-a and the capability set 220-b may be associated with a same set of operations (e.g., features) but different parameters associated with the set of operations. Additionally, or alternatively, the capability set 220-a and the capability set 220-b may be associated with a same set of parameters but different sets of operations. Additionally, the UE 115-a may support a single capability set 220 for each of the candidate configurations 210-b and the candidate configuration 210-c. For example, the UE 115-a may support a capability set 220-c for the candidate configuration 210-b and a capability set 220-d for the candidate configuration 210-c. In some cases, the UE 115-a may not support a candidate configuration 210, such as the candidate configuration 210-d. In such cases, the UE 115-a may refrain from indicating a capability set 220 associated with the candidate configuration 210-d. As such, the UE 115-a may transmit the capability message 215 indicating the capability set 220-a, the capability set 220-b, the capability set 220-c, and the capability set 220-d.

As such, the network entity 105-a may transmit, to the UE 115-a, a control message 225 indicating configuration information based on the capability message 215. That is, the network entity 105-a may select a candidate configuration 210 from the one or more candidate configurations 210 indicated in the capability query 205 based on the capability sets 220 and may transmit the control message 225 indicating configuration information in accordance with the selected candidate configuration 210. Additionally, the network entity 105-a may repeat the aforementioned procedure (e.g., transmitting a capability query 205 and receiving a capability message 215) one or more times (e.g., on demand, as needed when the UE 115-a is in an RRC connected state).

In some cases, capability reporting may be performed by the UE 115-a in multiple stages. For example, the UE 115-a may transmit, prior to the capability query 205 (e.g., during initial access), an additional capability message 215 indicating a capability for the UE 115-a to support capabilities queries 205 (e.g., responding to capability queries 205), a duration (e.g., timeline) associated with responding to a capability query 205, or both. Additionally, or alternatively, the additional capability message 215 (e.g., or another capability message 215) may indicate a default capability set 220 (e.g., the UE 115-a may under-report capabilities). That is, the default capability set 220 may indicate a set of features (e.g., operations) supported by the UE 115-a and the network entity 105-a may transmit a capability query 205 indicating a candidate configuration 210 further indicating a set of parameters (e.g., bands, BCs, more advanced features) associated with one or more features of the set of features. For example, the UE 115-a may report, via the additional capability message 215, a set of capabilities (e.g., basic capability set 220, default capability set 220) that the UE 115-a may support for any band combination and the network entity 105-a may transmit a capability query 205 indicating (e.g., via one or more candidate configurations 210) one or more bands (e.g., or BOBCs) associated with the set of capabilities. In such cases, parameters (e.g., constraints) associated with the set of capabilities during initial reporting (e.g., via the additional capability message 215) may be more relaxed (e.g., than when responding to a capability query 205). That is, multi-stage capability reporting may enable the UE 115-a to report the capabilities of the UE 115-a more confidently (e.g., with a higher level of accuracy), even for scenarios that are not fully tested (e.g., considered) by under-reporting, in a first stage, and then report more granular (e.g., more specific) capabilities of the UE 115-a for candidate configurations 210 indicated (e.g., explicitly) by the network entity 105-a in a second stage.

In some cases, the UE 115-a may not be fast enough (e.g., smart enough) to determine one or more capability sets 220 for one or more candidate configurations 210 indicated via a capability query 205 (e.g., within a threshold duration expected by the network entity 105-a). As such, as described previously, the UE 115-a may indicate, to the network entity 105-a, a threshold duration associated with responding to capability queries 205. Additionally, or alternatively, the UE 115-a may support a machine learning model (e.g., artificial intelligence) to enable responding to capability queries 205. That is, the UE 115-a may input, into a machine learning model, the one or more candidate configurations 210, such that the machine learning model may output the one or more capability sets 220 for the one or more candidate configurations 210.

Transmitting capability queries 205 may enable the network entity 105-a to reduce scheduling complexity (e.g., increase case of configuration) and may enable the UE 115-a to reduce (e.g., or avoid) under-reporting UE capabilities.

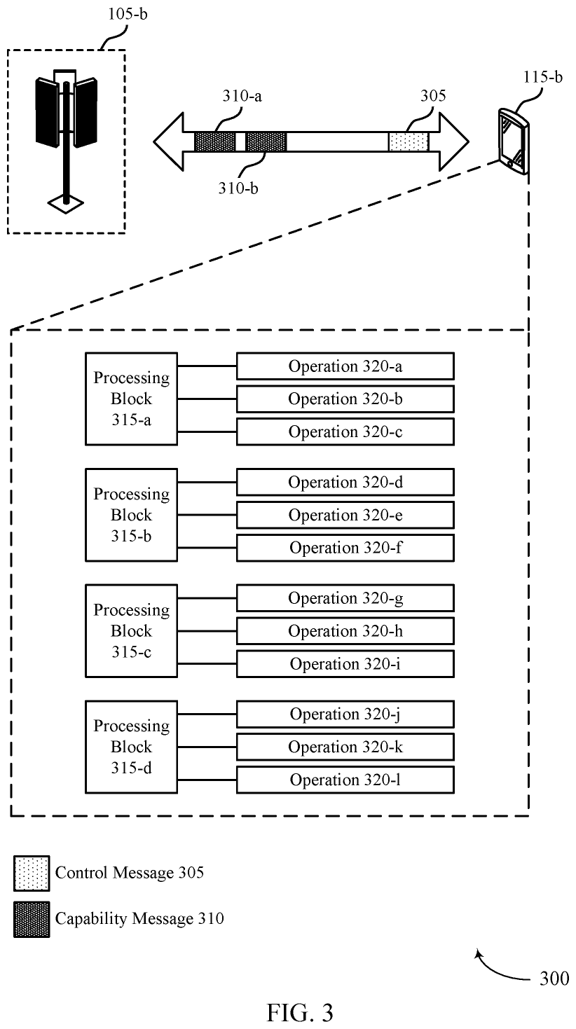

FIG. 3 shows an example of a wireless communications system 300 that supports techniques for capability reporting in accordance with one or more aspects of the present disclosure. In some cases, the wireless communications system 300 may implement or be implemented by aspects of the wireless communications system 100, the wireless communications system 200, or both. For example, the wireless communications system 300 may include one or more UEs 115 (e.g., a UE 115-b) and one or more network entities 105 (e.g., a network entity 105-b), which may be examples of the corresponding devices as described herein.

Some wireless communications systems, such as the wireless communications system 300, may support improved resource utilization and reduce latency associated with capability reporting through reporting of capability processing blocks 315, which may be referred to as processing blocks 315. That is, in some cases, a UE 115, such as the UE 115-b, may determine one or more threshold processing powers of the UE 115-b. The one or more threshold processing powers may be referred to as maximum processing units (MPUs), minimum processing units, or the like thereof. An MPU may define a first threshold (e.g., maximum) processing power supported by the UE 115-b and a minimum processing unit may define a second threshold (e.g., minimum) processing power supported by the UE 115-b. That is, the UE 115-b may not be able to perform one or more functions (e.g., or operate) above the first threshold processing power, below the second threshold processing power, or both.

Additionally, or alternatively, the one or more threshold processing powers may be based on a class of the UE 115-b, a category of the UE 115-b, or both. For example, a first minimum processing unit and a first MPU may be defined for a first type of UE 115-b (e.g., redcap device), a second minimum processing unit and a second MPU may be associated with a second type of UE 115-b (e.g., mobile device, smartphone), and a third minimum processing unit and a third MPU may be defined for a third type of UE 115-b (e.g., customer premise equipment (CPE)). In such cases, any combination of the first minimum processing unit, the second minimum processing unit, and the third minimum processing unit may be the same or different and any combination of the first MPU, the second MPU, and the third MPU may be the same or different. In some cases, the one or more threshold processing powers may be pre-configured at the UE 115-b (e.g., specified by standards documentation).

Additionally, the UE 115-b may determine a set of processing blocks 315 supported by the UE 115-b, such as a processing block 315-a, a processing block 315-b, a processing block 315-c, and a processing block 315-d. Each processing block 315 may be associated with one or more operations 320 (e.g., features, capabilities) supported by the UE 115-b. For example, the processing block 315-a may be associated with an operation 320-a, an operation 320-b, and an operation 320-c, the processing block 315-b may be associated with an operation 320-d, an operation 320-e, and an operation 320-f, the processing block 315-c may be associated with an operation 320-g, an operation 320-h, and an operation 320-i, and the processing block 315-d may be associated with an operation 320-j, an operation 320-k, and an operation 320-l. In some cases, an operation 320 associated with a processing block 315 may be an overall operation 320 performed through a series of sub-operations 320.

In some cases, each processing block 315 may be associated with a set of operations 320 determined by the UE 115-b. That is, the UE 115-b may assign each operation 320 supported by the UE 115-b, such as time tracking, frequency tracking, channel estimation, encoding, decoding, demapping, waveform generation, or the like thereof, to a processing block 315. In such cases, multiple operations 320 assigned to a same processing block 315 may be related (e.g., performed a larger function in combination) or may be random. Additionally, or alternatively, each processing block 315 may be associated with a set of operations 320 pre-configured at the UE 115-b (e.g., specified by standards documentation). For example, the processing block 315-a may be associated with operations 320 for physical downlink control channel (PDCCH) decoding, the processing block 315-b may be associated with operations 320 for physical downlink shared channel (PDSCH) decoding, the processing block 315-c may be associated with operations 320 for physical uplink control channel (PUCCH) transmission, and the processing block 315-d may be associated with operations 320 for physical uplink shared channel (PUSCH) transmission. Other processing blocks 315 may be associated with operations for synchronization signal block (SSB) monitoring, channel state information (CSI) reporting, or the like thereof.

Additionally, the UE 115-b may determine (e.g., identify, assign) one or more processing powers (e.g., usage, cost, processing power consumption) associated with each processing block 315. That is, a processing power associated with a processing block 315 may indicate a cumulative power consumption (e.g., processing power consumption, summation of processing powers) associated with the UE 115-b performing operations 320 assigned to the processing block 315. In such cases, the one or more processing powers associated with each processing block 315 may be based on a reference configuration of the UE 115-b. For example, the reference configuration may define one or more of a bandwidth (BW), a subcarrier spacing (SCS), a quantity (e.g., number) of layers, or the like thereof, such that the processing power for each processing block 315 is based on the UE 115-b performing the operations 320 associated with the processing block 315 in accordance with the reference configuration (e.g., BW, SCS, quantity of layers). In some cases, the reference configuration may be associated with one or more threshold values (e.g., minimum values) for performing the operations 320 (e.g., associated with any reported processing block 315). That is, for example, the operation 320-a may be associated with a first threshold SCS (e.g., first minimum SCS) and the operation 320-b may be associated with a second threshold SCS (e.g., second minimum SCS), where the first threshold SCS is less than the second threshold SCS. As such, a reference configuration used by the UE 115-b may be based on the second threshold SCS (e.g., due to the second threshold SCS being less than the first SCS). In some cases, a reference configuration may be based on a type of UE 115, a class of UE 115, or both (e.g., a new set of reference configurations may be defined for reduced capability UEs 115).

In some cases, the UE 115-b may determine a single processing power associated with each processing block 315. Additionally, or alternatively, the UE 115-b may determine multiple processing powers associated with each processing block 315, such that a cumulative processing power for a processing block 315 may be based on a sum of the multiple processing powers. In such cases, each of the multiple processing powers may be based on an operation 320 (e.g., or a set of operations 320) associated with the processing block 315.

Further, each processing block 315 may be assigned (e.g., associated with) a scaling factor. The scaling factor may indicate a change in processing power based on a change in reference configuration (e.g., for operating under different configurations). That is, a change in reference configuration may, for example, be a change in one or more parameters (e.g., BW, SCS, quantity of layers, etc.) associated with the reference configuration. In some cases, a scaling factor may be associated with a range. That is, in some cases (e.g., for a mandatory feature), a range of possible values for a parameter of a reference configuration may not be unlimited (e.g., may not include infinity, may have a limit to the scaling), such that the parameter may be scaled up to a threshold value (e.g., or not below a threshold value). In some other cases (e.g., for optional features that a UE 115 does not support), the range of possible values for the parameter of the reference configuration may be unlimited (e.g., may include infinity, may be scaled indefinitely), such that there is no threshold value to which the parameter may not be scaled above (e.g., or below).

For example, the processing block 315-a may be associated with the UE 115-b operating downlink carrier aggregation (DL-CA) across a first frequency range (e.g., FR1) and a second frequency range (e.g., FR3). As such, the UE 115-b may determine a cumulative processing power for the processing block 315-a based on a reference configuration indicating a first reference BW associated with the first frequency range, such as 100 MHz, and a second reference BW associated with the second frequency range, such as 100 MHz. The cumulative processing power (e.g., MPUₜₒₜₐₗ) for the processing block 315-a may be a sum of a first processing power (e.g., MPU_{FR1}) associated with operating DL-CA in the first frequency range and a second processing power (e.g., MPU_{FR3}) associated with operating DL-CA in the second frequency range (e.g., MPUₜₒₜₐₗ=MPU_{FR1}+MPU_{FR3}). Additionally, the UE 115-b may determine that doubling the BW in the first frequency range (e.g., for each unit increase in BW) results in the first processing power associated with operating DL-CA in the first frequency range increasing by the first processing power (e.g., doubling), such that a scaling factor associated with operating DL-CA in the first frequency range is 1:1. Similarly, the UE 115-b may determine that doubling the BW in the second frequency range results in the second processing power associated with operating DL-CA in the second frequency range increasing by twice the second processing power, such that a scaling factor associated with operating DL-CA in the second frequency range is 1:3. As such, a cumulative processing power for the processing block 315-a may be calculated according to the following Equation 1:

$$Processing Power = \frac{Configured {BW}_{1}}{Ref {BW}_{1}} {c}_{1} + \frac{3 \times Configured {BW}_{3}}{Ref {BW}_{3}} {c}_{3} \qquad ( 1 )$$

where Configured BW₁ may represent a BW configured for the UE 115-b in the first frequency range, Configured BW₃ may represent a BW configured for the UE 115-b in the second frequency range, Ref BW₁ may represent the first reference bandwidth, Ref BW₃ may represent the second reference bandwidth, c₁ may represent the first processing power associated with operating DL-CA in the first frequency range, and c₃ may represent the second processing power associated with operating DL-CA in the second frequency range. As discussed in more detail below, the calculated Processing Power may be less than the one or more threshold processing powers.

As such, to enable capability reporting, the UE 115-b may transmit a capability message 310-a indicating the one or more threshold processing powers associated with the UE 115-b. Additionally, the UE 115-b may transmit a capability message 310-b indicating the set of processing blocks 315 supported by the UE 115-b. The capability message 310-b may further include an indication of a processing power (e.g., one or more processing powers, a cumulative processing power made up of multiple processing powers) associated with each processing block 315, a scaling factor associated with each processing block 315, and a reference configuration associated with the processing powers. For example, continuing with the example described above, the UE 115-b may transmit the capability message 310 indicating the processing block 315-a, the cumulative processing power including the first processing power associated with operating DL-CA in the first frequency range and the second processing power associated with operating DL-CA in the second frequency range, the reference configuration including the first reference BW and the second reference BW, and both the 1:1 scaling factor for the first frequency range and the 1:3 scaling factor for the second frequency range.

As such, the network entity 105-b may select (e.g., combine) one or more processing blocks 315 from the set of processing blocks 315 and determine a sum of processing powers associated with the one or more selected processing blocks 315 according to a candidate (e.g., desired) configuration of the UE 115-b. In such cases, the sum of the processing powers associated with the one or more selected processing blocks 315 may be less than the one or more threshold processing powers. That is, the network entity 105-b may select the one or more processing blocks 315 and select (e.g., determine) operational parameters for the operations 320 associated with the one or more processing blocks 315 (e.g., determine configuration information) to support the sum of the processing powers being less than the one or more threshold processing powers. In such cases, the network entity 105-b may determine the sum of the processing powers based at least in part on the scaling factors associated with the one or more processing blocks 315. As such, in some cases, the network entity 105-b may determine (e.g., implicitly) a threshold configuration (e.g., maximum possible setting) for a processing block 315 (e.g., building block) based on the one or more threshold processing powers. However, the network entity 105-b determining the threshold configuration may result in uncertainly relating to hardware capabilities of the UE 115-b (e.g., hardware scoping). For example, the UE 115-b may be associated with (e.g., sized) a capability to perform Fast Fourier Transform (FFT) of a given size in a given duration, where performing FFT is associated with the processing block 315. However, the UE 115-b using less processing power for other processing blocks 315 may not result in the UE 115-b being associated with a larger FFT capability (e.g., the UE 115-b may have a maximum capability for one or more operations 320). As such, in some cases, the capability message 310-b may include a threshold value (e.g., maximum value) associated with scaling a reference configuration for a given processing block 315 or operation 320.

In some cases, the network entity 105-a may select the one or more processing blocks 315 based on desired operations 320 to be performed by the UE 115-b and may determine configuration information (e.g., operational parameters) for the one or more selected processing blocks 315 based on the one or more threshold processing powers (e.g., select the processing blocks 315 first and operational parameters second, where the operational parameters are selected to ensure the sum of the processing powers is less than the one or more threshold processing powers). Additionally, or alternatively, the network entity 105-a may determine desired configuration information (e.g., desired operational parameters, such as a desired BW, a desired SCS, etc.) and may select the one or more processing blocks 315 based on the one or more threshold processing powers (e.g., select the operational parameters first and the processing blocks 315 second, where the processing blocks 315 are selected to ensure the sum of the processing powers is less than the one or more threshold processing powers).

Thus, the network entity 105-c may transmit, to the UE 115-b, a control message 305 indicating configuration information in accordance with the one or more selected processing blocks 315 (e.g., and the determined operational parameters).

Returning to the discussion of the one or more threshold processing powers, in some examples, the one or more threshold processing powers may be per UE class or per UE class per frequency range. That is, a total processing power capability of the UE 115-b may not be 1:1 across frequency ranges, such that the UE 115-b may be associated with a threshold processing power per frequency range (e.g., MPU fr₁, MPU frₐ, MPU frₐ). Additionally, a sum total threshold processing power (e.g., overall processing power capability) of the UE 115 may or may not be equal to a sum of the threshold processing powers for each frequency range. As such, the UE 115-b may determine (e.g., and report) a sum total threshold processing power. In some cases, the UE 115-a may determine that the sum total threshold processing power is greater than or equal to the sum of the threshold processing powers for each frequency range (e.g., MPUₜₒₜₐₗ≥ΣMPU frᵢ). In some other cases (e.g., to avoid under reporting for scenarios when the UE 115-b is configured in a single frequency range), the sum total threshold processing power may be greater than or equal to the sum of weighted values of the threshold processing powers for each frequency range (e.g., MPU total≥ΣW frᵢ×MPU frᵢ), where a weight associated with each frequency range is determined based on which CCs (e.g., a quantity of CCs) are aggregated on the frequency range.

For example, a processing power of the UE 115-b may be determined (e.g., set) as MPU fr₁=X₁, MPU fr₃=X₃, and MPUₜₒₜₐₗ=X≥w₁X₁+w₃X₃. In some cases, for in band combinations with all CCs in the first frequency range, w₁ may equal 1 and w₃ may equal 0. In some other cases, for in band combinations with all CCs in the second frequency range, w₁ may equal 0 and w₃ may equal 1. In some other cases, for in band combinations with CCs in the first frequency range and in the second frequency range, w₁ may equal 0.5 and w₃ may equal 0.3. To summarize, the UE 115-b may define a sum total threshold processing power (e.g., MPU total) and define a threshold processing power per frequency range (e.g., MPU fr₁ and MPU fr₃), where the sum total threshold processing power and the threshold processing powers per frequency range should satisfy MPUₜₒₜₐₗ≥Σw frᵢ×MPU frᵢ, where weights are dependent on the frequency ranges from which a BC is formed, on a quantity (e.g., number) of CCs in each band of the BC, or both. In such cases, the UE 115-b may report, to the network entity 105-b, an indication of the weights (e.g., for when a BC includes bands from multiple frequency ranges).

Additionally, in some cases, the one or more threshold processing powers may be based on BCs. For example, the UE 115-b may support a first band (e.g. B1) and a second band (e.g., B3) and may report a capability of the UE 115-b to support the first band and the second band in a first frequency range (e.g., FR1). As such, the UE 115-b may report a sum total threshold processing power (e.g., total MPU) and a first threshold processing power associated with the first frequency band (e.g., assuming they are equal). Additionally, the UE 115-b may report a processing power and a scaling factor for a reference configuration for the first band and the second band. However, a processing block 315 may be associated with uplink power control and may be associated with two modes, including dynamic for CA and semi-static for DC. Additionally, the first band may support a CA combination with the second band and may support a DC combination with a third band. As such, a first threshold processing power for the CA combination (e.g., first band and second band BC) may be different than a second threshold processing power for the DC combination (e.g., first band and third band BC), such that the UE 115-b reports the first threshold processing power and the second threshold processing power. In other words, the UE 115-b may report the one or more threshold processing powers, the processing powers associated with the processing blocks 315, and the scaling factors (e.g., and any other parameters) per BC, per BOBC, or both.

Additionally, in some cases, the processing powers, the scaling factors, or both, associated with the processing blocks 315 may be based on frequency range. Additionally, or alternatively, some radio frequency parameters (e.g., requirements) may be band dependent. For example, meeting certain error vector magnitude (EVM) threshold for high modulation orders may be easier in lower bands than in higher bands. As such, the processing powers, the scaling factors, or both, associated with the processing blocks 315 may be per band. In some cases, some processing powers, some scaling factors, or both (e.g., non-radio frequency parameters), associated with the processing blocks 315 may be common and may be reported per frequency range (e.g., and not per band).

In some cases, the UE 115-b may support multi-RAT (mRAT) DC. In such cases, for bands not included in a mRAT BC, the UE 115-b may report capabilities of the UE 115-b based on a requested (e.g., by the network entity 105-b) BC. That is, a sum total threshold processing power (e.g., MPU) and each threshold processing power per frequency range (e.g., for 6G bands in the requested BC) may be reported for the requested BC. In other words, the sum total threshold processing power may be for the requested BC and each threshold processing power per frequency range may be for bands in a given frequency range in the requested BC (e.g., for bands in the request BC where the UE 115-a is operating under 6G). In some other cases, the UE 115-b may not report capabilities of the UE 115-b based on a requested BC (e.g., the UE 115-b may under report). That is, in some cases, the UE 115-a may under report capabilities of the UE 115-a.

In some cases, the UE 115-b may support single RAT DC. In such cases, the UE 115-b may report a single threshold processing power (e.g., processing blocks 315 are interchangeable across cell groups). In some other cases, the UE 115-b may report (e.g., separately) a threshold processing power per cell group (CG), where a sum of threshold processing powers associated with multiple CGs is less than a sum total threshold processing power (e.g., MPU_{MCG}+MPU_{SCG}≤MPUₜₒₜₐₗ). In such cases, a threshold processing power associated with a specific CG may have a similar function as the sum total threshold processing power for the specific CG (e.g., the specific CG may satisfy the threshold processing power associated with the specific CG). For example, a first sum of processing powers associated with one or more selected processing bocks 315 for a master cell group (MCG) may be less than a first threshold processing power associated with the MCG (e.g., Σwfrᵢ·MPUfrᵢ≤MPU_{total, MCG}) and a second sum of processing powers associated with one or more selected processing bocks 315 for a secondary cell group (SCG) may be less than a second threshold processing power associated with the SCG (e.g., Σwfrᵢ·MPUfrᵢ≤MPU_{total, SCG}), where a sum of the first sum and the second sum is less than a sum total threshold processing power for all CGs (e.g., MPU_{total, MCG}+MPU_{total, SCG}≤MPUₜₒₜₐₗ).

In some cases, resources for operations 320 (e.g., processing blocks 315) performed by the UE 115-b may be pooled together. In some other cases, some operations 320 may be associated with dedicate resources (e.g., blocks). Additionally, or alternatively, some operations 320 may share hardware while others may not. As such, the UE 115-b may be associated with (e.g., may have, may define) one or more buckets, where each bucket includes processing blocks 315 that may share resources. In such cases, the buckets may be pre-configured at the UE 115-b (e.g., fixed) or may be defined and reported by the UE 115-b. As such, each bucket may be associated with an equation for calculating a processing power associated with the bucket. That is, operations 320, processing blocks 315, processing powers, scaling factors, or any combination thereof, associated with a bucket may be input into a matrix.

In some cases, the UE 115-b may combine techniques described with reference to FIG. 3 with techniques described with reference to FIG. 3. That is, the network entity 105-b may transmit, to the UE 115-b, a control message 305 indicating one or more candidate configurations for the UE 115-b, such that the UE 115-b may transmit, in response to the control message 305, a capability message 310 indicating one or more sets of processing blocks 315 for the one or more candidate configurations and a processing power associated with each of the processing blocks 315 (e.g., or set of processing blocks 315), where a reference configuration used to determine the processing powers is based on the one or more candidate configurations. That is, the UE 115-b may indicate that, for a processing block 315, a first processing power may be associated with a first candidate configuration, a second processing power may be associated with a second candidate configuration, and a third processing power may be associated with a third candidate configuration.

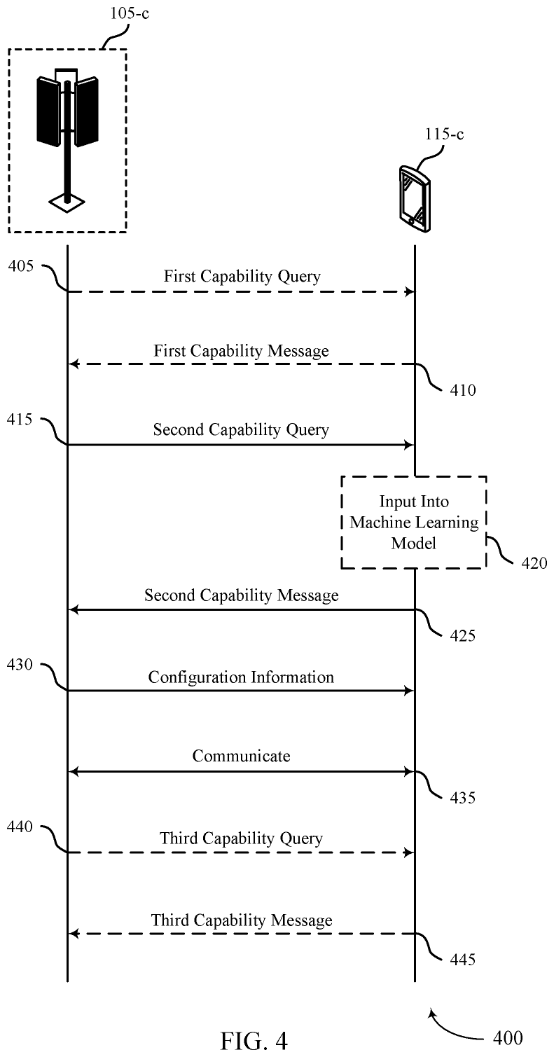

FIG. 4 shows an example of a process flow 400 that supports techniques for capability reporting in accordance with one or more aspects of the present disclosure. In some cases, the process flow 400 may implement or be implemented by aspects of the wireless communications system 100, the wireless communications system 200, the wireless communications system 300, or any combination thereof. For example, the process flow 400 may include one or more UEs 115 (e.g., a UE 115-c) and one or more network entities 105 (e.g., a network entity 105-c), which may be examples of the corresponding devices as described herein.

In some cases (e.g., during an initial access procedure), at 405, the UE 115-c may receive, from the network entity 105-c, a first capability query requesting one or more default UE capabilities (e.g., under-reported by the UE 15-c). In some cases, the first capability query may additionally, or alternatively, request if the UE 115-c supports capability queries, a timeline (e.g., a threshold duration) associated with responding to capability queries, or both.

In some cases (e.g., during the initial access procedure), at 410, the UE 115-c may transmit, to the network entity 105-c, a first capability message indicating the capability of the UE 115-c to respond to capability queries. In such cases, the first capability message may include an indication of the threshold duration associated with responding to a capability query. In some cases, the UE 115-c may report (e.g., under report), via the first capability message (e.g., or another capability message), an indication of one or more UE capabilities (e.g., the one or more default UE capabilities) associated with multiple candidate UE configurations. That is, the one or more UE capabilities may be universal, or default, capabilities for configurations of the UE (e.g., all UE configurations).

At 415, the UE 115-c may receive, from the network entity 105-c, a second capability query requesting one or more UE capabilities associated with a set of candidate UE configurations (e.g., from the multiple candidate UE capabilities). That is, the second capability query may request the UE 115-c to report one or more capabilities of the UE 115-c for each candidate configuration of the set of candidate UE configurations. In such cases, each candidate UE configuration of the set of candidate UE configurations may include an indication of one or more bands, one or more BCs, one or more BOBCs, one or more CCs, one or more BWs, one or more parameters associated with MIMO communications, a threshold (e.g., maximum) quantity of layers, or any combination thereof.

In some cases, at 420, the UE 115-c may input into a machine learning model, the set of candidate UE configurations to determine at least a subset of the one or more capabilities of the UE 115-c for the set of candidate UE configurations. That is, the machine learning model may output the at least subset of the one or more capabilities requested via the second capability query.

At 425, the UE 115-c may transmit, to the network entity 105-c, a second capability message, in response to the second capability query, indicating the at least subset of the one or more capabilities requested via the second capability query. In such cases, each UE capability of the at least subset of the one or more UE capabilities may be associated with performing one or more UE operations in accordance with a candidate UE configuration from the set of candidate UE configurations.

In some cases, the UE 115-c may not support (e.g., may not have capabilities for) a candidate UE configuration of the set of candidate UE configurations. In such cases, the UE 115-c may refrain from reporting a capability (e.g., of the one or more capabilities) to support the candidate UE configuration (e.g., from the set of candidate UE configurations).

As such, at 430, the network entity 105-c may transmit, to the UE 115-c, a control message indicating configuration information associated with at least one candidate UE configuration from the set of candidate UE configurations based on the second capability message.

At 435, the UE 115-c and the network entity 105-c may communicate in accordance with the configuration information.

In some cases, the network entity 105-c may repeat the capability query process. That is, at 440, the network entity 105-c may transmit, to the UE 115-c, a third capability query requesting one or more second UE capabilities associated with a second set of candidate UE configurations. As such, at 445, the UE 115-c may transmit, to the network entity 105-c in response to the third capability query, a third capability message indicating at least a subset of the one or more second UE capabilities associated with the second set of candidate UE configurations.

Though described in the context of capability messages responsive to capabilities queries, this is not a limitation of the present disclosure. In this regard, the UE 115-c may transmit a capability message without receiving a capability query (e.g., a capability message that is not in response to a capability query. For example, the UE 115-c may transmit a capability query based on an update associated with one or more capabilities of the UE 115-c.

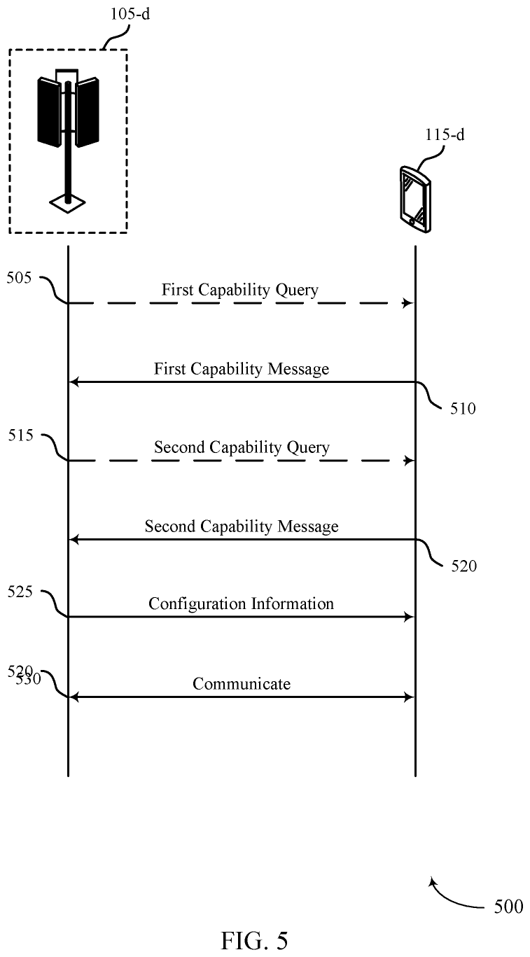

FIG. 5 shows an example of a process flow 500 that supports techniques for capability reporting in accordance with one or more aspects of the present disclosure. In some cases, the process flow 500 may implement or be implemented by aspects of the wireless communications system 100, the wireless communications system 200, the wireless communications system 300, the process flow 400, or any combination thereof. For example, the process flow 500 may include one or more UEs 115 (e.g., a UE 115-d) and one or more network entities 105 (e.g., a network entity 105-d), which may be examples of the corresponding devices as described herein.

In some cases, at 505, the network entity 105-d may transmit, to the UE 115-d, a first capability query requesting if the UE 115-d supports indicating one or more capabilities of the UE 115-d via a set of candidate UE operations, a set of threshold processing power capabilities of the UE 115-d, or both.

At 510, the UE 115-d may transmit, to the network entity 105-d (e.g., responsive to the first capability query), a first capability message indicating the set of threshold processing power capabilities of the UE 115-d for performing UE operations. In such cases, the set of threshold processing power capabilities may include one or more maximum processing power capabilities (e.g., MPU), one or more minimum processing power capabilities, or both. In some cases, each of the one or more first threshold processing power capabilities of the UE 115-d may be based on a band of the respective frequency range (e.g., MPU_{fr}), a BC of the respective frequency range, a BOBC of the respective frequency range, or any combination thereof. In such cases, the UE 115-c may transmit, via the first capability message, an indication of one or more bands, one or more BCs, or both, supported by the UE 115-d (e.g., as well as if the UE 115-d supports single CC, CA, DC, mRAT, etc.). Additionally, or alternatively, the set of threshold processing power capabilities may be based on a type of the UE 115-d, a category of the UE 115-d, a cell group, or any combination thereof.

Additionally, or alternatively, the set of threshold processing power capabilities may include a first threshold processing power capability of the UE 115-d indicating a total (e.g., sum total) processing power capability of the UE 115-d and one or more second threshold processing power capabilities of the UE 115-d based on a respective frequency range from multiple frequency ranges. In such cases, the second threshold processing power capability of the UE 115-d may be based on a respective weighting factor associated with each frequency range of the set of frequency ranges, where each weighting factor scales a second threshold processing power of the one or more second threshold processing power capabilities associated with a respective frequency range of the set of frequency ranges relative to other frequency ranges of the set of frequency ranges. In some cases, the UE 115-c may transmit, via the first capability message, an indication of the weighting factors associated with the plurality of frequency ranges.

In some cases, at 515, the network entity 105-d may transmit, to the UE 115-d, a second capability query requesting the set of candidate UE operations supported by the UE 115-d.

At 520, the UE 115-d may transmit, to the network entity 105-d (e.g., responsive to the second capability query), a second capability message indicating the set of candidate UE operations (e.g., processing blocks), processing powers (e.g., costs) associated with performing the set of candidate UE operations, a reference configuration defining one or more operational parameters for each candidate UE operation of the set of candidate UE operations, and a scaling factor indicating a change in the processing powers associated with performing the set of candidate UE operations relative to a change in the one or more operational parameters.

In some cases, each candidate UE operation of the set of candidate UE operations includes one or more second UE operations. In such cases, the set of candidate UE operations may be pre-configured at the UE 115-d. Additionally, or alternatively, the set of candidate UE operations may include each operation supported by the UE 115-d.

In some cases, the processing powers, the scaling factor, or both, may be based on a frequency range associated with the reference configuration, a band associated with the reference configuration, or both. Additionally, or alternatively, the one or more operational parameters may include a band, a BC, a BOBC, a bandwidth, a SCS, a frequency, a quantity of layers, or any combination thereof.

In some cases, the UE 115-c may transmit the set of candidate UE operations, the processing powers associated with performing the set of candidate UE operations, the reference configuration, and the scaling factor via a matrix.

At 525, the network entity 105-d may output (e.g., transmit), to the UE 115-d, a control message indicating configuration information associated with one or more candidate UE operations of the set of candidate UE operations, where a summation of processing powers associated with the one or more candidate UE operations is less than or equal to the set of threshold processing power capabilities of the UE 115-d.

At 530, the UE 115-d and the network entity 105-d may communicate in accordance with the configuration information.

Though described in the context of capability messages responsive to capabilities queries, this is not a limitation of the present disclosure. In this regard, the UE 115-d may transmit a capability message without receiving a capability query (e.g., a capability message that is not in response to a capability query. For example, the UE 115-d may transmit a capability query based on an update associated with one or more capabilities of the UE 115-d.

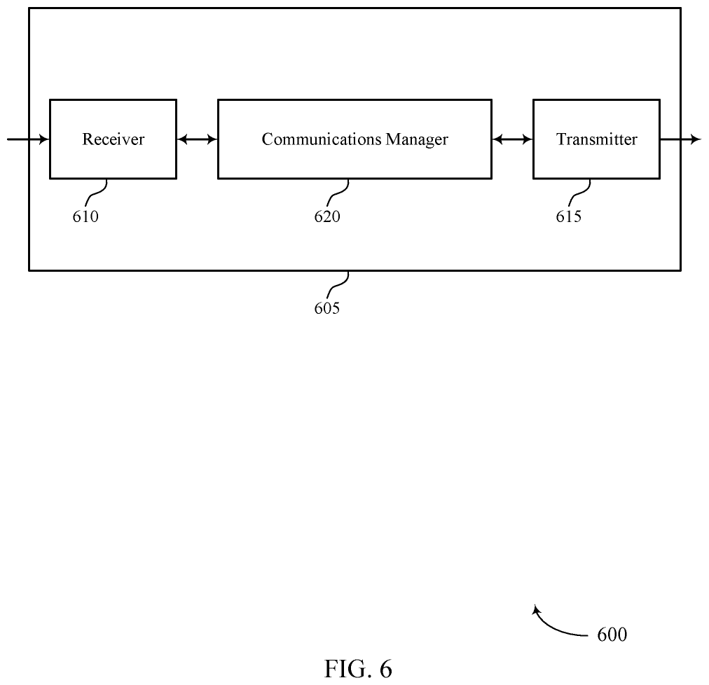

FIG. 6 shows a block diagram 600 of a device 605 that supports techniques for capability reporting in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for capability reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for capability reporting). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for capability reporting for 6G communications as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving, from a network entity, a capability query requesting one or more UE capabilities associated with a set of candidate UE configurations. The communications manager 620 is capable of, configured to, or operable to support a means for transmitting, in response to the capability query, a capability message indicating at least a subset of the one or more UE capabilities associated with the set of candidate UE configurations. The communications manager 620 is capable of, configured to, or operable to support a means for receiving, from the network entity, a control message indicating configuration information associated with at least one candidate UE configuration from the set of candidate UE configurations. The communications manager 620 is capable of, configured to, or operable to support a means for communicating with the network entity in accordance with the configuration information.

Additionally, or alternatively, the communications manager 620 may support wireless communications in accordance with examples as disclosed herein. For example, the communications manager 620 is capable of, configured to, or operable to support a means for transmitting, to a network entity, a first capability message indicating a set of threshold processing power capabilities of the UE for performing UE operations. The communications manager 620 is capable of, configured to, or operable to support a means for transmitting, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. The communications manager 620 is capable of, configured to, or operable to support a means for receiving, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE. The communications manager 620 is capable of, configured to, or operable to support a means for communicating with the network entity in accordance with the configuration information.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for capability reporting for 6G communications which may result in reduced processing, reduced power consumption, and more efficient utilization of communication resources, among other advantages.

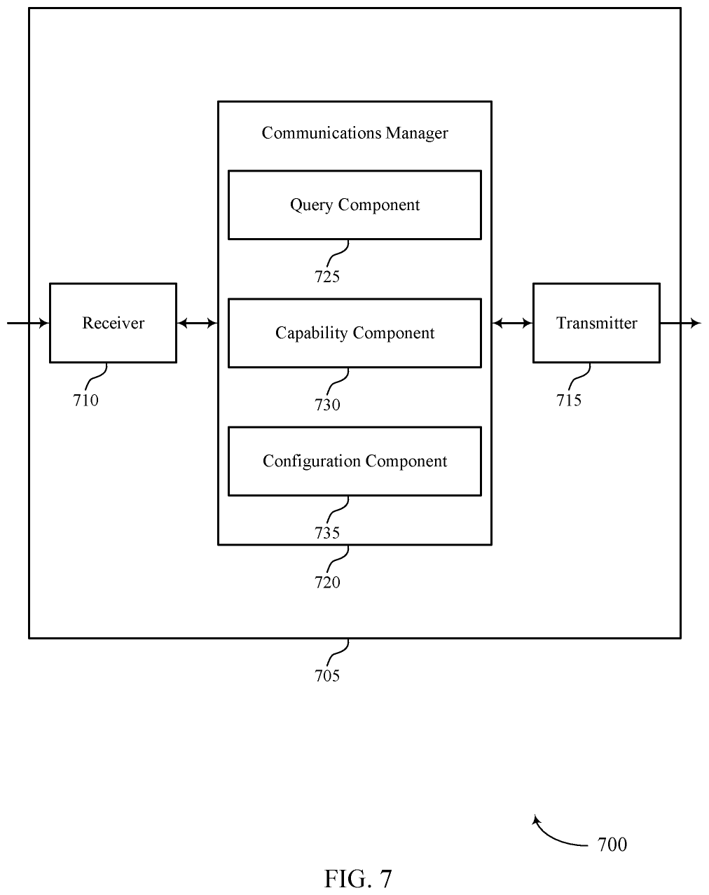

FIG. 7 shows a block diagram 700 of a device 705 that supports techniques for capability reporting in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for capability reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for capability reporting). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for capability reporting for 6G communications as described herein. For example, the communications manager 720 may include a query component 725, a capability component 730, a configuration component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The query component 725 is capable of, configured to, or operable to support a means for receiving, from a network entity, a capability query requesting one or more UE capabilities associated with a set of candidate UE configurations. The capability component 730 is capable of, configured to, or operable to support a means for transmitting, in response to the capability query, a capability message indicating at least a subset of the one or more UE capabilities associated with the set of candidate UE configurations. The configuration component 735 is capable of, configured to, or operable to support a means for receiving, from the network entity, a control message indicating configuration information associated with at least one candidate UE configuration from the set of candidate UE configurations. The configuration component 735 is capable of, configured to, or operable to support a means for communicating with the network entity in accordance with the configuration information.

Additionally, or alternatively, the communications manager 720 may support wireless communications in accordance with examples as disclosed herein. The capability component 730 is capable of, configured to, or operable to support a means for transmitting, to a network entity, a first capability message indicating a set of threshold processing power capabilities of the UE for performing UE operations. The capability component 730 is capable of, configured to, or operable to support a means for transmitting, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. The configuration component 735 is capable of, configured to, or operable to support a means for receiving, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE. The configuration component 735 is capable of, configured to, or operable to support a means for communicating with the network entity in accordance with the configuration information.

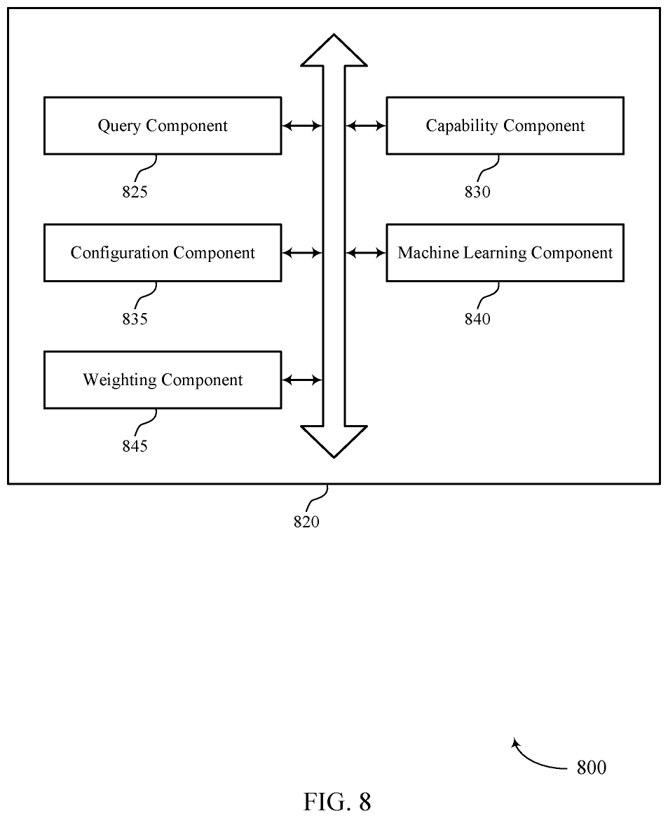

FIG. 8 shows a block diagram 800 of a communications manager 820 that supports techniques for capability reporting in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for capability reporting for 6G communications as described herein. For example, the communications manager 820 may include a query component 825, a capability component 830, a configuration component 835, a machine learning component 840, a weighting component 845, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The query component 825 is capable of, configured to, or operable to support a means for receiving, from a network entity, a capability query requesting one or more UE capabilities associated with a set of candidate UE configurations. The capability component 830 is capable of, configured to, or operable to support a means for transmitting, in response to the capability query, a capability message indicating at least a subset of the one or more UE capabilities associated with the set of candidate UE configurations. The configuration component 835 is capable of, configured to, or operable to support a means for receiving, from the network entity, a control message indicating configuration information associated with at least one candidate UE configuration from the set of candidate UE configurations. In some examples, the configuration component 835 is capable of, configured to, or operable to support a means for communicating with the network entity in accordance with the configuration information.

In some examples, the capability component 830 is capable of, configured to, or operable to support a means for transmitting, in response to a second capability query received prior to the capability query, a second capability message indicating a capability of the UE to respond to the capability query, where receiving the capability query is based on transmitting the second capability message.

In some examples, the second capability message includes an indication of a threshold duration associated with responding to the capability query.

In some examples, to support transmitting the second capability message, the capability component 830 is capable of, configured to, or operable to support a means for transmitting an indication of one or more second UE capabilities associated with a set of multiple candidate UE configurations including at least the set of candidate UE configurations.

In some examples, the second capability message is transmitted during an initial access procedure with the network entity.

In some examples, each UE capability of the at least subset of the one or more UE capabilities is associated with performing one or more UE operations in accordance with a candidate UE configuration from the set of candidate UE configurations.

In some examples, the query component 825 is capable of, configured to, or operable to support a means for receiving a second capability query requesting one or more second UE capabilities associated with a second set of candidate UE configurations. In some examples, the capability component 830 is capable of, configured to, or operable to support a means for transmitting, in response to the second capability query, a second capability message indicating at least a subset of the one or more second UE capabilities associated with the second set of candidate UE configurations.

In some examples, each candidate UE configuration of the set of candidate UE configurations includes an indication of one or more bands, one or more band combinations, one or more band of band combinations, one or more component carriers, one or more bandwidths, one or more parameters associated with multiple input multiple output communications, a threshold quantity of layers, or any combination thereof.

In some examples, the machine learning component 840 is capable of, configured to, or operable to support a means for inputting, into a machine learning model, the set of candidate UE configurations, where transmitting the capability message indicating the at least subset of the one or more UE capabilities is based on the machine learning model outputting the at least subset of the one or more UE capabilities.

Additionally, or alternatively, the communications manager 820 may support wireless communications in accordance with examples as disclosed herein. In some examples, the capability component 830 is capable of, configured to, or operable to support a means for transmitting, to a network entity, a first capability message indicating a set of threshold processing power capabilities of the UE for performing UE operations. In some examples, the capability component 830 is capable of, configured to, or operable to support a means for transmitting, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. In some examples, the configuration component 835 is capable of, configured to, or operable to support a means for receiving, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE. In some examples, the configuration component 835 is capable of, configured to, or operable to support a means for communicating with the network entity in accordance with the configuration information.

In some examples, each candidate UE operation of the set of multiple candidate UE operations includes one or more second UE operations. In some examples, the set of multiple candidate UE operations are pre-configured at the UE.

In some examples, the set of multiple candidate UE operations includes each operation supported by the UE.

In some examples, the set of threshold processing power capabilities includes one or more maximum processing power capabilities, one or more minimum processing power capabilities, or both.

In some examples, the set of threshold processing power capabilities includes a first threshold processing power capability of the UE indicating a total processing power capability of the UE and one or more second threshold processing power capabilities of the UE based on a respective frequency range from a set of multiple frequency ranges.

In some examples, the first threshold processing power capability of the UE is based on a respective weighting factor associated with each frequency range of a set of multiple frequency ranges, where each weighting factor scales a second threshold processing power of the one or more second threshold processing power capabilities associated with a respective frequency range of the set of multiple frequency ranges relative to other frequency ranges of the set of multiple frequency ranges.

In some examples, to support transmitting the first capability message, the weighting component 845 is capable of, configured to, or operable to support a means for transmitting an indication of the weighting factors associated with the set of multiple frequency ranges.

In some examples, each of the one or more second threshold processing power capabilities of the UE are further based on a band of the respective frequency range, a band combination of the respective frequency range, a band of band combination of the respective frequency range, or any combination thereof.

In some examples, the capability component 830 is capable of, configured to, or operable to support a means for transmitting an indication of one or more bands, one or more band combinations, or both, supported by the UE.

In some examples, the processing powers, the scaling factor, or both, are based on a frequency range associated with the reference configuration, a band associated with the reference configuration, or both.

In some examples, the set of threshold processing power capabilities are based on a type of the UE, a category of the UE, or both.

In some examples, the set of threshold processing power capabilities are based on a cell group.

In some examples, the one or more operational parameters includes a band, a band combination, a band of band combination, a bandwidth, a subcarrier spacing, a frequency, a quantity of layers, or any combination thereof.

In some examples, to support transmitting the second capability message, the capability component 830 is capable of, configured to, or operable to support a means for transmitting a matrix indicating the set of multiple candidate UE operations, the processing powers associated with performing the set of multiple candidate UE operations, the reference configuration, and the scaling factor.

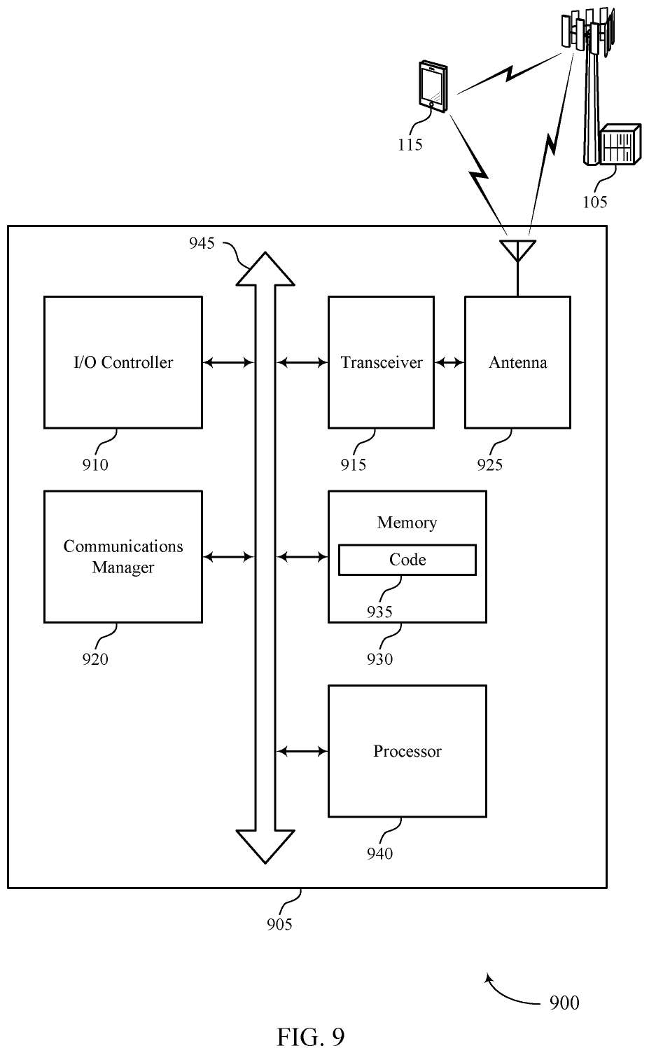

FIG. 9 shows a diagram of a system 900 including a device 905 that supports techniques for capability reporting in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for capability reporting for 6G communications). For example, the device 905 or a component of the device 905 may include at least one processor 940 and at least one memory 930 coupled with or to the at least one processor 940, the at least one processor 940 and the at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving, from a network entity, a capability query requesting one or more UE capabilities associated with a set of candidate UE configurations. The communications manager 920 is capable of, configured to, or operable to support a means for transmitting, in response to the capability query, a capability message indicating at least a subset of the one or more UE capabilities associated with the set of candidate UE configurations. The communications manager 920 is capable of, configured to, or operable to support a means for receiving, from the network entity, a control message indicating configuration information associated with at least one candidate UE configuration from the set of candidate UE configurations. The communications manager 920 is capable of, configured to, or operable to support a means for communicating with the network entity in accordance with the configuration information.

Additionally, or alternatively, the communications manager 920 may support wireless communications in accordance with examples as disclosed herein. For example, the communications manager 920 is capable of, configured to, or operable to support a means for transmitting, to a network entity, a first capability message indicating a set of threshold processing power capabilities of the UE for performing UE operations. The communications manager 920 is capable of, configured to, or operable to support a means for transmitting, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. The communications manager 920 is capable of, configured to, or operable to support a means for receiving, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE. The communications manager 920 is capable of, configured to, or operable to support a means for communicating with the network entity in accordance with the configuration information.

By including or configuring the communications manager 920 in accordance with examples as described herein, the device 905 may support techniques capability reporting for 6G communications which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for capability reporting for 6G communications as described herein, or the at least one processor 940 and the at least one memory 930 may be otherwise configured to, individually or collectively, perform or support such operations.

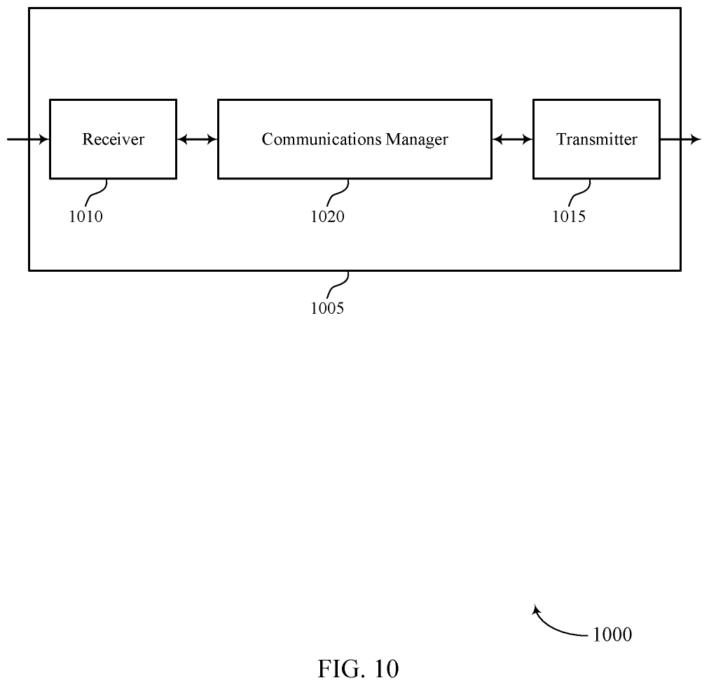

FIG. 10 shows a block diagram 1000 of a device 1005 that supports techniques for capability reporting in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for capability reporting for 6G communications as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting, to a UE, a capability query requesting one or more UE capabilities associated with a set of candidate UE configurations. The communications manager 1020 is capable of, configured to, or operable to support a means for obtaining, in response to the capability query, a capability message indicating at least a subset of the one or more UE capabilities associated with the set of candidate UE configurations. The communications manager 1020 is capable of, configured to, or operable to support a means for outputting a control message indicating configuration information associated with at least one candidate UE configuration from the set of candidate UE configurations. The communications manager 1020 is capable of, configured to, or operable to support a means for communicating with the UE in accordance with the configuration information.

Additionally, or alternatively, the communications manager 1020 may support wireless communications in accordance with examples as disclosed herein. For example, the communications manager 1020 is capable of, configured to, or operable to support a means for obtaining, from a UE, a first capability message indicating a set of threshold processing power capabilities of the UE for performing UE operations. The communications manager 1020 is capable of, configured to, or operable to support a means for obtaining, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. The communications manager 1020 is capable of, configured to, or operable to support a means for outputting, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE. The communications manager 1020 is capable of, configured to, or operable to support a means for communicating with the UE in accordance with the configuration information.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for capability reporting for 6G communications which may result in reduced processing, reduced power consumption, and more efficient utilization of communication resources, among other advantages.

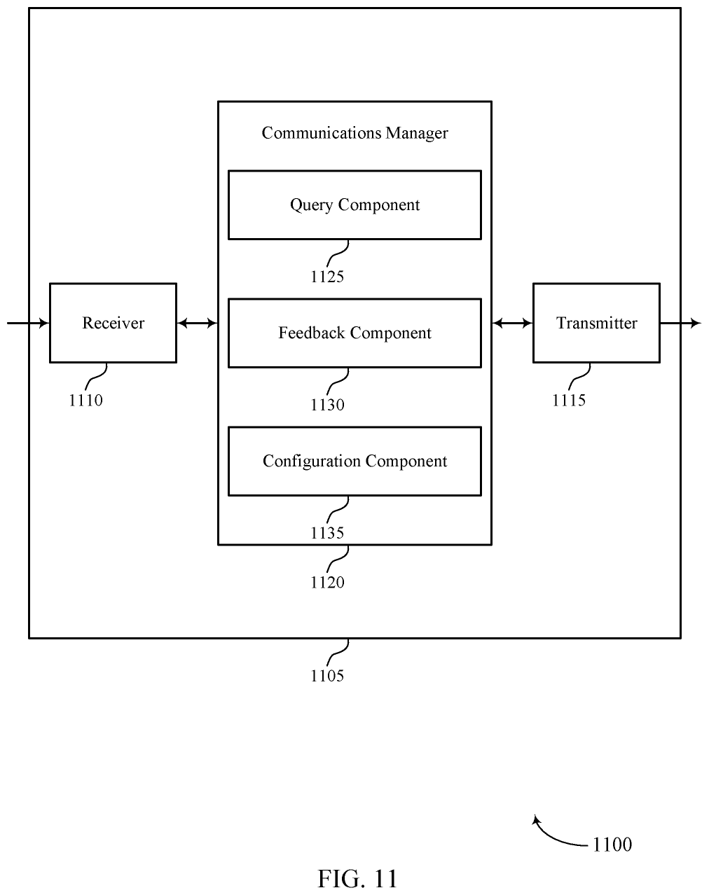

FIG. 11 shows a block diagram 1100 of a device 1105 that supports techniques for capability reporting in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for capability reporting for 6G communications as described herein. For example, the communications manager 1120 may include a query component 1125, a feedback component 1130, a configuration component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The query component 1125 is capable of, configured to, or operable to support a means for outputting, to a UE, a capability query requesting one or more UE capabilities associated with a set of candidate UE configurations. The feedback component 1130 is capable of, configured to, or operable to support a means for obtaining, in response to the capability query, a capability message indicating at least a subset of the one or more UE capabilities associated with the set of candidate UE configurations. The configuration component 1135 is capable of, configured to, or operable to support a means for outputting a control message indicating configuration information associated with at least one candidate UE configuration from the set of candidate UE configurations. The configuration component 1135 is capable of, configured to, or operable to support a means for communicating with the UE in accordance with the configuration information.

Additionally, or alternatively, the communications manager 1120 may support wireless communications in accordance with examples as disclosed herein. The feedback component 1130 is capable of, configured to, or operable to support a means for obtaining, from a UE, a first capability message indicating a set of threshold processing power capabilities of the UE for performing UE operations. The feedback component 1130 is capable of, configured to, or operable to support a means for obtaining, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. The configuration component 1135 is capable of, configured to, or operable to support a means for outputting, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE. The configuration component 1135 is capable of, configured to, or operable to support a means for communicating with the UE in accordance with the configuration information.

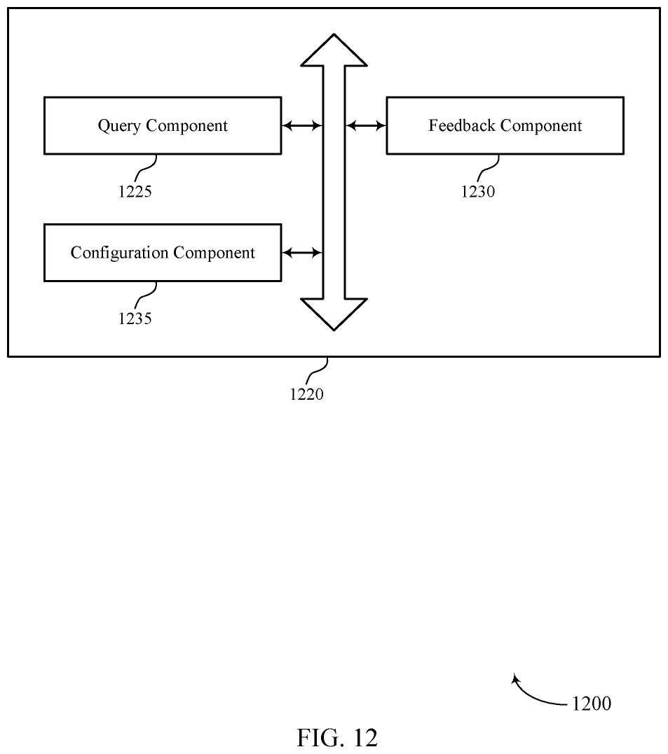

FIG. 12 shows a block diagram 1200 of a communications manager 1220 that supports techniques for capability reporting in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for capability reporting for 6G communications as described herein. For example, the communications manager 1220 may include a query component 1225, a feedback component 1230, a configuration component 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The query component 1225 is capable of, configured to, or operable to support a means for outputting, to a UE, a capability query requesting one or more UE capabilities associated with a set of candidate UE configurations. The feedback component 1230 is capable of, configured to, or operable to support a means for obtaining, in response to the capability query, a capability message indicating at least a subset of the one or more UE capabilities associated with the set of candidate UE configurations. The configuration component 1235 is capable of, configured to, or operable to support a means for outputting a control message indicating configuration information associated with at least one candidate UE configuration from the set of candidate UE configurations. In some examples, the configuration component 1235 is capable of, configured to, or operable to support a means for communicating with the UE in accordance with the configuration information.

In some examples, the feedback component 1230 is capable of, configured to, or operable to support a means for obtaining, in response to a second capability query output prior to the capability query, a second capability message indicating a capability of the UE to respond to the capability query, where obtaining the capability query is based on outputting the second capability message.

In some examples, the second capability message includes an indication of a threshold duration associated with responding to the capability query.

In some examples, to support obtaining the second capability message, the feedback component 1230 is capable of, configured to, or operable to support a means for obtaining an indication of one or more second UE capabilities associated with a set of multiple candidate UE configurations including at least the set of candidate UE configurations.

In some examples, the second capability message is obtained during an initial access procedure with the UE.

In some examples, each UE capability of the at least subset of the one or more UE capabilities is associated with performing one or more UE operations in accordance with a candidate UE configuration from the set of candidate UE configurations.

In some examples, the query component 1225 is capable of, configured to, or operable to support a means for outputting a second capability query requesting one or more second UE capabilities associated with a second set of candidate UE configurations. In some examples, the feedback component 1230 is capable of, configured to, or operable to support a means for obtaining, in response to the second capability query, a second capability message indicating at least a subset of the one or more second UE capabilities associated with the second set of candidate UE configurations.

In some examples, each candidate UE configuration of the set of candidate UE configurations includes an indication of one or more bands, one or more band combinations, one or more band of band combinations, one or more component carriers, one or more bandwidths, one or more parameters associated with multiple input multiple output communications, a threshold quantity of layers, or any combination thereof.

Additionally, or alternatively, the communications manager 1220 may support wireless communications in accordance with examples as disclosed herein. In some examples, the feedback component 1230 is capable of, configured to, or operable to support a means for obtaining, from a UE, a first capability message indicating a set of threshold processing power capabilities of the UE for performing UE operations. In some examples, the feedback component 1230 is capable of, configured to, or operable to support a means for obtaining, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. In some examples, the configuration component 1235 is capable of, configured to, or operable to support a means for outputting, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE. In some examples, the configuration component 1235 is capable of, configured to, or operable to support a means for communicating with the UE in accordance with the configuration information.

In some examples, each candidate UE operation of the set of multiple candidate UE operations includes one or more second UE operations. In some examples, the set of multiple candidate UE operations are pre-configured at the UE.

In some examples, the set of multiple candidate UE operations includes each operation supported by the UE.

In some examples, the set of threshold processing power capabilities includes one or more maximum processing power capabilities, one or more minimum processing power capabilities, or both.

In some examples, the set of threshold processing power capabilities includes a first threshold processing power capability of the UE indicating a total processing power capability of the UE and one or more second threshold processing power capabilities of the UE based on a respective frequency range from a set of multiple frequency ranges.

In some examples, the second threshold processing power capability of the UE is based on a respective weighting factor associated with each frequency range of a set of multiple frequency ranges, where each weighting factor scales a second threshold processing power of the one or more second threshold processing power capabilities associated with a respective frequency range of the set of multiple frequency ranges relative to other frequency ranges of the set of multiple frequency ranges.

In some examples, to support obtaining the first capability message, the feedback component 1230 is capable of, configured to, or operable to support a means for obtaining an indication of the weighting factors associated with the set of multiple frequency ranges.

In some examples, each of the one or more first threshold processing power capabilities of the UE are further based on a band of the respective frequency range, a band combination of the respective frequency range, a band of band combination of the respective frequency range, or any combination thereof.

In some examples, the feedback component 1230 is capable of, configured to, or operable to support a means for obtaining an indication of one or more bands, one or more band combinations, or both, supported by the UE.

In some examples, the processing powers, the scaling factor, or both, are based on a frequency range associated with the reference configuration, a band associated with the reference configuration, or both.

In some examples, the set of threshold processing power capabilities are based on a type of the UE, a category of the UE, or both.

In some examples, the set of threshold processing power capabilities are based on a cell group.

In some examples, the one or more operational parameters includes a band, a band combination, a band of band combination, a bandwidth, a subcarrier spacing, a frequency, a quantity of layers, or any combination thereof.

In some examples, to support obtaining the second capability message, the feedback component 1230 is capable of, configured to, or operable to support a means for obtaining a matrix indicating the set of multiple candidate UE operations, the processing powers associated with performing the set of multiple candidate UE operations, the reference configuration, and the scaling factor.

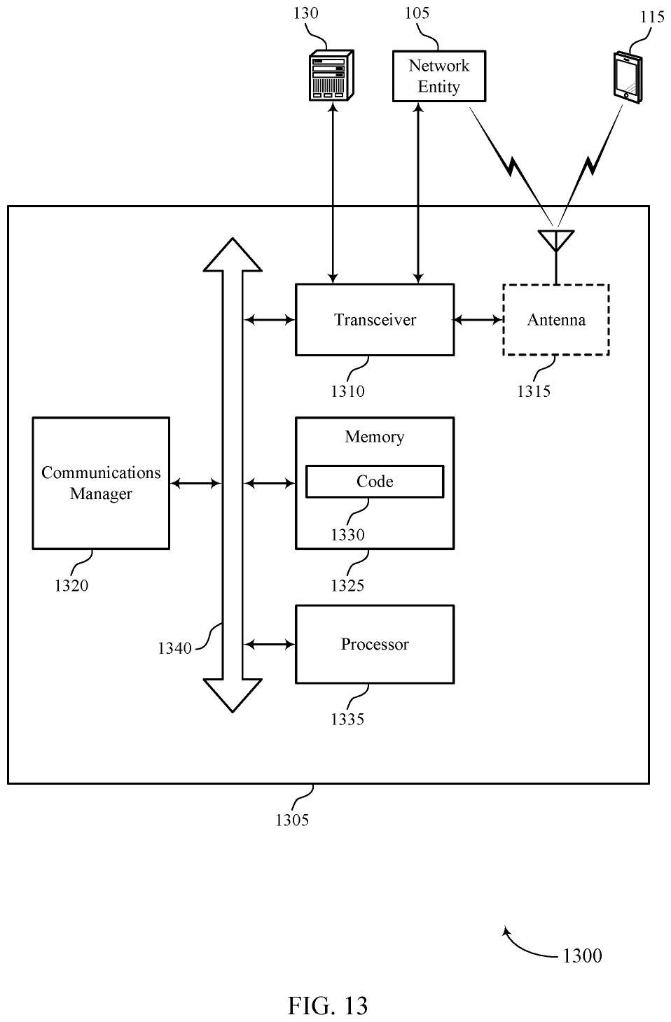

FIG. 13 shows a diagram of a system 1300 including a device 1305 that supports techniques for capability reporting in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for capability reporting for 6G communications). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network devices 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting, to a UE, a capability query requesting one or more UE capabilities associated with a set of candidate UE configurations. The communications manager 1320 is capable of, configured to, or operable to support a means for obtaining, in response to the capability query, a capability message indicating at least a subset of the one or more UE capabilities associated with the set of candidate UE configurations. The communications manager 1320 is capable of, configured to, or operable to support a means for outputting a control message indicating configuration information associated with at least one candidate UE configuration from the set of candidate UE configurations. The communications manager 1320 is capable of, configured to, or operable to support a means for communicating with the UE in accordance with the configuration information.

Additionally, or alternatively, the communications manager 1320 may support wireless communications in accordance with examples as disclosed herein. For example, the communications manager 1320 is capable of, configured to, or operable to support a means for obtaining, from a UE, a first capability message indicating a set of threshold processing power capabilities of the UE for performing UE operations. The communications manager 1320 is capable of, configured to, or operable to support a means for obtaining, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. The communications manager 1320 is capable of, configured to, or operable to support a means for outputting, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE. The communications manager 1320 is capable of, configured to, or operable to support a means for communicating with the UE in accordance with the configuration information.

By including or configuring the communications manager 1320 in accordance with examples as described herein, the device 1305 may support techniques for capability reporting for 6G communications which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for capability reporting for 6G communications as described herein, or the at least one processor 1335 and the at least one memory 1325 may be otherwise configured to, individually or collectively, perform or support such operations.

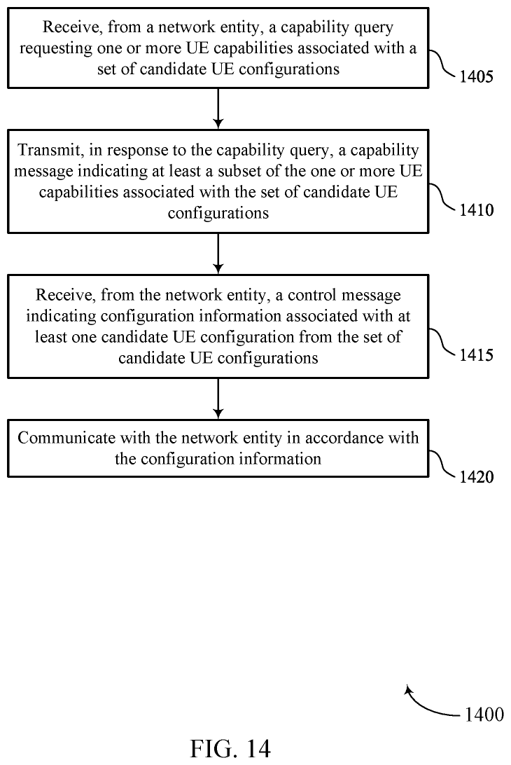

FIG. 14 shows a flowchart illustrating a method 1400 that supports techniques for capability reporting in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a capability query requesting one or more UE capabilities associated with a set of candidate UE configurations. The operations of 1405 may be performed in accordance with examples as disclosed herein. In some examples, aspects of the operations of 1405 may be performed by a query component 825 as described with reference to FIG. 8.

At 1410, the method may include transmitting, in response to the capability query, a capability message indicating at least a subset of the one or more UE capabilities associated with the set of candidate UE configurations. The operations of 1410 may be performed in accordance with examples as disclosed herein. In some examples, aspects of the operations of 1410 may be performed by a capability component 830 as described with reference to FIG. 8.

At 1415, the method may include receiving, from the network entity, a control message indicating configuration information associated with at least one candidate UE configuration from the set of candidate UE configurations. The operations of 1415 may be performed in accordance with examples as disclosed herein. In some examples, aspects of the operations of 1415 may be performed by a configuration component 835 as described with reference to FIG. 8.

At 1420, the method may include communicating with the network entity in accordance with the configuration information. The operations of 1420 may be performed in accordance with examples as disclosed herein. In some examples, aspects of the operations of 1420 may be performed by a configuration component 835 as described with reference to FIG. 8.

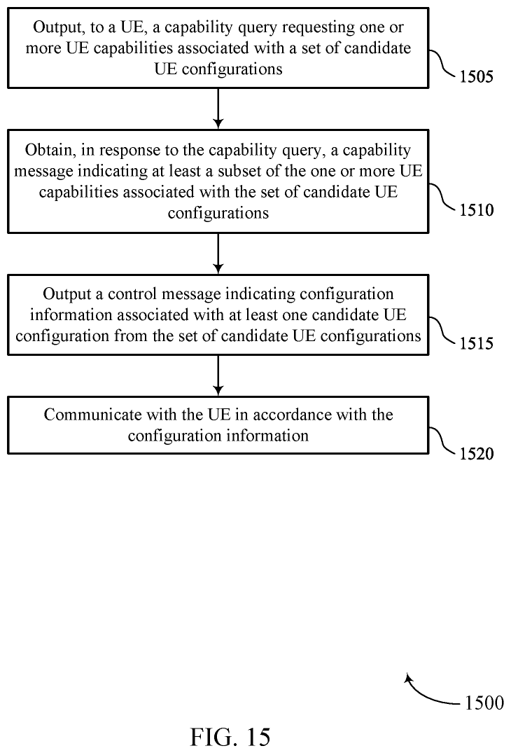

FIG. 15 shows a flowchart illustrating a method 1500 that supports techniques for capability reporting in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a UE, a capability query requesting one or more UE capabilities associated with a set of candidate UE configurations. The operations of 1505 may be performed in accordance with examples as disclosed herein. In some examples, aspects of the operations of 1505 may be performed by a query component 1225 as described with reference to FIG. 12.

At 1510, the method may include obtaining, in response to the capability query, a capability message indicating at least a subset of the one or more UE capabilities associated with the set of candidate UE configurations. The operations of 1510 may be performed in accordance with examples as disclosed herein. In some examples, aspects of the operations of 1510 may be performed by a feedback component 1230 as described with reference to FIG. 12.

At 1515, the method may include outputting a control message indicating configuration information associated with at least one candidate UE configuration from the set of candidate UE configurations. The operations of 1515 may be performed in accordance with examples as disclosed herein. In some examples, aspects of the operations of 1515 may be performed by a configuration component 1235 as described with reference to FIG. 12.

At 1520, the method may include communicating with the UE in accordance with the configuration information. The operations of 1520 may be performed in accordance with examples as disclosed herein. In some examples, aspects of the operations of 1520 may be performed by a configuration component 1235 as described with reference to FIG. 12.

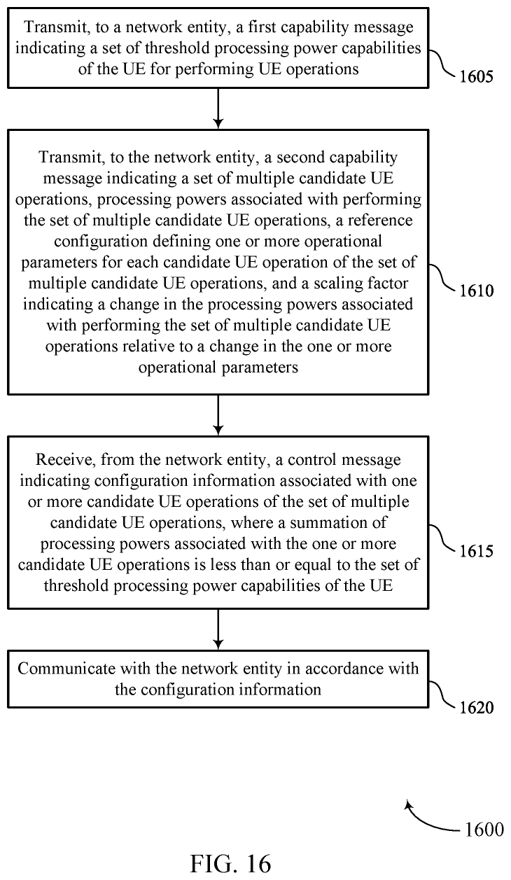

FIG. 16 shows a flowchart illustrating a method 1600 that supports techniques for capability reporting in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting, to a network entity, a first capability message indicating a set of threshold processing power capabilities of the UE for performing UE operations. The operations of 1605 may be performed in accordance with examples as disclosed herein. In some examples, aspects of the operations of 1605 may be performed by a capability component 830 as described with reference to FIG. 8.

At 1610, the method may include transmitting, to the network entity, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. The operations of 1610 may be performed in accordance with examples as disclosed herein. In some examples, aspects of the operations of 1610 may be performed by a capability component 830 as described with reference to FIG. 8.

At 1615, the method may include receiving, from the network entity, a control message indicating configuration information associated with one or more candidate UE operations of the set of multiple candidate UE operations, where a summation of processing powers associated with the one or more candidate UE operations is less than or equal to the set of threshold processing power capabilities of the UE. The operations of 1615 may be performed in accordance with examples as disclosed herein. In some examples, aspects of the operations of 1615 may be performed by a configuration component 835 as described with reference to FIG. 8.

At 1620, the method may include communicating with the network entity in accordance with the configuration information. The operations of 1620 may be performed in accordance with examples as disclosed herein. In some examples, aspects of the operations of 1620 may be performed by a configuration component 835 as described with reference to FIG. 8.

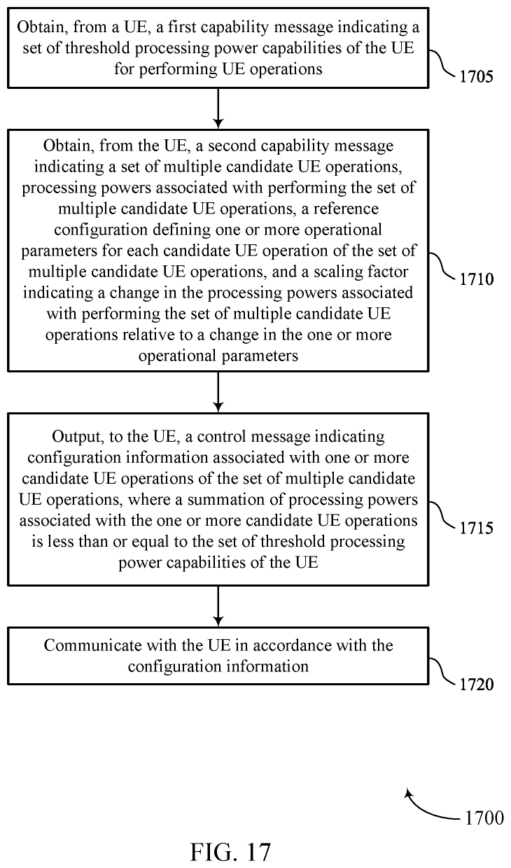

FIG. 17 shows a flowchart illustrating a method 1700 that supports techniques for capability reporting in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include obtaining, from a UE, a first capability message indicating a set of threshold processing power capabilities of the UE for performing UE operations. The operations of 1705 may be performed in accordance with examples as disclosed herein. In some examples, aspects of the operations of 1705 may be performed by a feedback component 1230 as described with reference to FIG. 12.

At 1710, the method may include obtaining, from the UE, a second capability message indicating a set of multiple candidate UE operations, processing powers associated with performing the set of multiple candidate UE operations, a reference configuration defining one or more operational parameters for each candidate UE operation of the set of multiple candidate UE operations, and a scaling factor indicating a change in the processing powers associated with performing the set of multiple candidate UE operations relative to a change in the one or more operational parameters. The operations of 1710 may be performed in accordance with examples as disclosed herein. In some examples, aspects of the operations of 1710 may be performed by a feedback component 1230 as described with reference to FIG. 12.

At 1715, the method may include outputting, to the UE, a control message indicating configuration information associated with one or more candidate UE operations of the set of multiple candidate UE operations, where a summation of processing powers associated with the one or more candidate UE operations is less than or equal to the set of threshold processing power capabilities of the UE. The operations of 1715 may be performed in accordance with examples as disclosed herein. In some examples, aspects of the operations of 1715 may be performed by a configuration component 1235 as described with reference to FIG. 12.

At 1720, the method may include communicating with the UE in accordance with the configuration information. The operations of 1720 may be performed in accordance with examples as disclosed herein. In some examples, aspects of the operations of 1720 may be performed by a configuration component 1235 as described with reference to FIG. 12.

The following provides an overview of aspects of the present disclosure:

Aspect 1: A method for wireless communications at a UE, comprising: receiving, from a network entity, a capability query requesting one or more UE capabilities associated with a set of candidate UE configurations; transmitting, in response to the capability query, a capability message indicating at least a subset of the one or more UE capabilities associated with the set of candidate UE configurations; receiving, from the network entity, a control message indicating configuration information associated with at least one candidate UE configuration from the set of candidate UE configurations; and communicating with the network entity in accordance with the configuration information.

Aspect 2: The method of aspect 1, further comprising: transmitting, in response to a second capability query received prior to the capability query, a second capability message indicating a capability of the UE to respond to the capability query, wherein receiving the capability query is based at least in part on transmitting the second capability message.

Aspect 3: The method of aspect 2, wherein the second capability message comprises an indication of a threshold duration associated with responding to the capability query.

Aspect 4: The method of any of aspects 2 through 3, wherein transmitting the second capability message comprises: transmitting an indication of one or more second UE capabilities associated with a plurality of candidate UE configurations comprising at least the set of candidate UE configurations.

Aspect 5: The method of any of aspects 2 through 4, wherein the second capability message is transmitted during an initial access procedure with the network entity.

Aspect 6: The method of any of aspects 1 through 5, wherein each UE capability of the at least subset of the one or more UE capabilities is associated with performing one or more UE operations in accordance with a candidate UE configuration from the set of candidate UE configurations.

Aspect 7: The method of any of aspects 1 through 6, further comprising: receiving a second capability query requesting one or more second UE capabilities associated with a second set of candidate UE configurations; and transmitting, in response to the second capability query, a second capability message indicating at least a subset of the one or more second UE capabilities associated with the second set of candidate UE configurations.

Aspect 8: The method of any of aspects 1 through 7, wherein each candidate UE configuration of the set of candidate UE configurations comprises an indication of one or more bands, one or more BCs, one or more BOBCs, one or more CCs, one or more BWs, one or more parameters associated with MIMO communications, a threshold quantity of layers, or any combination thereof.

Aspect 9: The method of any of aspects 1 through 8, further comprising: inputting, into a machine learning model, the set of candidate UE configurations, wherein transmitting the capability message indicating the at least subset of the one or more UE capabilities is based at least in part on the machine learning model outputting the at least subset of the one or more UE capabilities.

Aspect 10: A method for wireless communications at a network entity, comprising: outputting, to a UE, a capability query requesting one or more UE capabilities associated with a set of candidate UE configurations; obtaining, in response to the capability query, a capability message indicating at least a subset of the one or more UE capabilities associated with the set of candidate UE configurations; outputting a control message indicating configuration information associated with at least one candidate UE configuration from the set of candidate UE configurations; and communicating with the UE in accordance with the configuration information.

Aspect 11: The method of aspect 10, further comprising: obtaining, in response to a second capability query output prior to the capability query, a second capability message indicating a capability of the UE to respond to the capability query, wherein obtaining the capability query is based at least in part on outputting the second capability message.

Aspect 12: The method of aspect 11, wherein the second capability message comprises an indication of a threshold duration associated with responding to the capability query.

Aspect 13: The method of any of aspects 11 through 12, wherein obtaining the second capability message comprises: obtaining an indication of one or more second UE capabilities associated with a plurality of candidate UE configurations comprising at least the set of candidate UE configurations.

Aspect 14: The method of any of aspects 11 through 13, wherein the second capability message is obtained during an initial access procedure with the UE.

Aspect 15: The method of any of aspects 10 through 14, wherein each UE capability of the at least subset of the one or more UE capabilities is associated with performing one or more UE operations in accordance with a candidate UE configuration from the set of candidate UE configurations.

Aspect 16: The method of any of aspects 10 through 15, further comprising: outputting a second capability query requesting one or more second UE capabilities associated with a second set of candidate UE configurations; and obtaining, in response to the second capability query, a second capability message indicating at least a subset of the one or more second UE capabilities associated with the second set of candidate UE configurations.

Aspect 17: The method of any of aspects 10 through 16, wherein each candidate UE configuration of the set of candidate UE configurations comprises an indication of one or more bands, one or more BCs, one or more BOBCs, one or more CCs, one or more BWs, one or more parameters associated with MIMO communications, a threshold quantity of layers, or any combination thereof.

Aspect 18: A method for wireless communications at a UE, comprising: transmitting, to a network entity, a first capability message indicating a set of threshold processing power capabilities of the UE for performing UE operations; transmitting, to the network entity, a second capability message indicating a plurality of candidate UE operations, processing powers associated with performing the plurality of candidate UE operations, a reference configuration defining one or more operational parameters for each candidate UE operation of the plurality of candidate UE operations, and a scaling factor indicating a change in the processing powers associated with performing the plurality of candidate UE operations relative to a change in the one or more operational parameters; receiving, from the network entity, a control message indicating configuration information associated with one or more candidate UE operations of the plurality of candidate UE operations, wherein a summation of processing powers associated with the one or more candidate UE operations is less than or equal to the set of threshold processing power capabilities of the UE; and communicating with the network entity in accordance with the configuration information.

Aspect 19: The method of aspect 18, wherein each candidate UE operation of the plurality of candidate UE operations comprises one or more second UE operations, and the plurality of candidate UE operations are pre-configured at the UE.

Aspect 20: The method of any of aspects 18 through 19, wherein the plurality of candidate UE operations comprises each operation supported by the UE.

Aspect 21: The method of any of aspects 18 through 20, wherein the set of threshold processing power capabilities comprises one or more maximum processing power capabilities, one or more minimum processing power capabilities, or both.

Aspect 22: The method of any of aspects 18 through 21, wherein the set of threshold processing power capabilities comprises a first threshold processing power capability of the UE indicating a total processing power capability of the UE and one or more second threshold processing power capabilities of the UE based at least in part on a respective frequency range from a plurality of frequency ranges.

Aspect 23: The method of aspect 22, wherein the first threshold processing power capability of the UE is based at least in part on a respective weighting factor associated with each frequency range of a plurality of frequency ranges, where each weighting factor scales a second threshold processing power of the one or more second threshold processing power capabilities associated with a respective frequency range of the plurality of frequency ranges relative to other frequency ranges of the plurality of frequency ranges.

Aspect 24: The method of aspect 23, wherein transmitting the first capability message comprises: transmitting an indication of the weighting factors associated with the plurality of frequency ranges.

Aspect 25: The method of any of aspects 22 through 24, wherein each of the one or more second threshold processing power capabilities of the UE are further based at least in part on a band of the respective frequency range, a band combination of the respective frequency range, a band of band combination of the respective frequency range, or any combination thereof.

Aspect 26: The method of aspect 25, further comprising: transmitting an indication of one or more bands, one or more BCs, or both, supported by the UE.

Aspect 27: The method of any of aspects 18 through 26, wherein the processing powers, the scaling factor, or both, are based at least in part on a frequency range associated with the reference configuration, a band associated with the reference configuration, or both.

Aspect 28: The method of any of aspects 18 through 27, wherein the set of threshold processing power capabilities are based at least in part on a type of the UE, a category of the UE, or both.

Aspect 29: The method of any of aspects 18 through 28, wherein the set of threshold processing power capabilities are based at least in part on a cell group.

Aspect 30: The method of any of aspects 18 through 29, wherein the one or more operational parameters comprises a band, a band combination, a band of band combination, a BW, a subcarrier spacing, a frequency, a quantity of layers, or any combination thereof.

Aspect 31: The method of any of aspects 18 through 30, wherein transmitting the second capability message comprises: transmitting a matrix indicating the plurality of candidate UE operations, the processing powers associated with performing the plurality of candidate UE operations, the reference configuration, and the scaling factor.

Aspect 32: The method of any of aspects 18 through 31, wherein each of the first capability message and the second capability message are transmitted in response to a respective capability request.

Aspect 33: A method for wireless communications at a network entity, comprising: obtaining, from a UE, a first capability message indicating a set of threshold processing power capabilities of the UE for performing UE operations; obtaining, from the UE, a second capability message indicating a plurality of candidate UE operations, processing powers associated with performing the plurality of candidate UE operations, a reference configuration defining one or more operational parameters for each candidate UE operation of the plurality of candidate UE operations, and a scaling factor indicating a change in the processing powers associated with performing the plurality of candidate UE operations relative to a change in the one or more operational parameters; outputting, to the UE, a control message indicating configuration information associated with one or more candidate UE operations of the plurality of candidate UE operations, wherein a summation of processing powers associated with the one or more candidate UE operations is less than or equal to the set of threshold processing power capabilities of the UE; and communicating with the UE in accordance with the configuration information

Aspect 34: The method of aspect 33, wherein each candidate UE operation of the plurality of candidate UE operations comprises one or more second UE operations, and the plurality of candidate UE operations are pre-configured at the UE.

Aspect 35: The method of any of aspects 33 through 34, wherein the plurality of candidate UE operations comprises each operation supported by the UE.

Aspect 36: The method of any of aspects 33 through 35, wherein the set of threshold processing power capabilities comprises one or more maximum processing power capabilities, one or more minimum processing power capabilities, or both.

Aspect 37: The method of any of aspects 33 through 36, wherein the set of threshold processing power capabilities comprises a first threshold processing power capability of the UE indicating a total processing power capability of the UE and one or more second threshold processing power capabilities of the UE based at least in part on a respective frequency range from a plurality of frequency ranges.

Aspect 38: The method of any of aspects 33 through 37, wherein the second threshold processing power capability of the UE is based at least in part on a respective weighting factor associated with each frequency range of a plurality of frequency ranges, where each weighting factor scales a second threshold processing power of the one or more second threshold processing power capabilities associated with a respective frequency range of the plurality of frequency ranges relative to other frequency ranges of the plurality of frequency ranges.

Aspect 39: The method of aspect 38, wherein obtaining the first capability message comprises: obtaining an indication of the weighting factors associated with the plurality of frequency ranges.

Aspect 40: The method of any of aspects 33 through 39, wherein each of the one or more first threshold processing power capabilities of the UE are further based at least in part on a band of the respective frequency range, a band combination of the respective frequency range, a band of band combination of the respective frequency range, or any combination thereof.

Aspect 41: The method of aspect 40, further comprising: obtaining an indication of one or more bands, one or more BCs, or both, supported by the UE.

Aspect 42: The method of any of aspects 33 through 41, wherein the processing powers, the scaling factor, or both, are based at least in part on a frequency range associated with the reference configuration, a band associated with the reference configuration, or both.

Aspect 43: The method of any of aspects 33 through 42, wherein the set of threshold processing power capabilities are based at least in part on a type of the UE, a category of the UE, or both.

Aspect 44: The method of any of aspects 33 through 43, wherein the set of threshold processing power capabilities are based at least in part on a cell group.

Aspect 45: The method of any of aspects 33 through 44, wherein the one or more operational parameters comprises a band, a band combination, a band of band combination, a BW, a subcarrier spacing, a frequency, a quantity of layers, or any combination thereof.

Aspect 46: The method of any of aspects 33 through 45, wherein obtaining the second capability message comprises: obtaining a matrix indicating the plurality of candidate UE operations, the processing powers associated with performing the plurality of candidate UE operations, the reference configuration, and the scaling factor.

Aspect 47: The method of any of aspects 33 through 46, wherein each of the first capability message and the second capability message are obtained in response to a respective capability request output by the network entity.

Aspect 48: A UE for wireless communications, comprising one or more memories storing processor-executable code, and one or more processors coupled with the one or more memories and individually or collectively operable to execute the code to cause the UE to perform a method of any of aspects 1 through 9.

Aspect 49: A UE for wireless communications, comprising at least one means for performing a method of any of aspects 1 through 9.

Aspect 50: A non-transitory computer-readable medium storing code for wireless communications, the code comprising instructions executable by one or more processors to perform a method of any of aspects 1 through 9.

Aspect 51: A network entity for wireless communications, comprising one or more memories storing processor-executable code, and one or more processors coupled with the one or more memories and individually or collectively operable to execute the code to cause the network entity to perform a method of any of aspects 10 through 17.

Aspect 52: A network entity for wireless communications, comprising at least one means for performing a method of any of aspects 10 through 17.

Aspect 53: A non-transitory computer-readable medium storing code for wireless communications, the code comprising instructions executable by one or more processors to perform a method of any of aspects 10 through 17.

Aspect 54: A UE for wireless communications, comprising one or more memories storing processor-executable code, and one or more processors coupled with the one or more memories and individually or collectively operable to execute the code to cause the UE to perform a method of any of aspects 18 through 32.

Aspect 55: A UE for wireless communications, comprising at least one means for performing a method of any of aspects 18 through 32.

Aspect 56: A non-transitory computer-readable medium storing code for wireless communications, the code comprising instructions executable by one or more processors to perform a method of any of aspects 18 through 32.

Aspect 57: A network entity for wireless communications, comprising one or more memories storing processor-executable code, and one or more processors coupled with the one or more memories and individually or collectively operable to execute the code to cause the network entity to perform a method of any of aspects 33 through 47.

Aspect 58: A network entity for wireless communications, comprising at least one means for performing a method of any of aspects 33 through 47.

Aspect 59: A non-transitory computer-readable medium storing code for wireless communications, the code comprising instructions executable by one or more processors to perform a method of any of aspects 33 through 47.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, a capability query requesting one or more UE capabilities associated with a set of candidate UE configurations;
transmit, in response to the capability query, a capability message indicating at least a subset of the one or more UE capabilities associated with the set of candidate UE configurations;
receive, from the network entity, a control message indicating configuration information associated with at least one candidate UE configuration from the set of candidate UE configurations; and
communicate with the network entity in accordance with the configuration information.

2. The UE of claim 1, wherein the one or more processors are individually or collectively further operable to execute the code to cause the UE to:
transmit, in response to a second capability query received prior to the capability query, a second capability message indicating a capability of the UE to respond to the capability query, wherein receiving the capability query is based at least in part on transmitting the second capability message.

3. The UE of claim 2, wherein the second capability message comprises an indication of a threshold duration associated with responding to the capability query.

4. The UE of claim 2, wherein, to transmit the second capability message, the one or more processors are individually or collectively operable to execute the code to cause the UE to:
transmit an indication of one or more second UE capabilities associated with a plurality of candidate UE configurations comprising at least the set of candidate UE configurations.

5. The UE of claim 2, wherein the second capability message is transmitted during an initial access procedure with the network entity.

6. The UE of claim 1, wherein each UE capability of the at least subset of the one or more UE capabilities is associated with performing one or more UE operations in accordance with a candidate UE configuration from the set of candidate UE configurations.

7. The UE of claim 1, wherein the one or more processors are individually or collectively further operable to execute the code to cause the UE to:
receive a second capability query requesting one or more second UE capabilities associated with a second set of candidate UE configurations; and
transmit, in response to the second capability query, a second capability message indicating at least a subset of the one or more second UE capabilities associated with the second set of candidate UE configurations.

8. The UE of claim 1, wherein each candidate UE configuration of the set of candidate UE configurations comprises an indication of one or more bands, one or more band combinations, one or more band of band combinations, one or more component carriers, one or more bandwidths, one or more parameters associated with multiple input multiple output communications, a threshold quantity of layers, or any combination thereof.

9. The UE of claim 1, wherein the one or more processors are individually or collectively further operable to execute the code to cause the UE to:
input, into a machine learning model, the set of candidate UE configurations, wherein transmitting the capability message indicating the at least subset of the one or more UE capabilities is based at least in part on the machine learning model outputting the at least subset of the one or more UE capabilities.

10. A network entity, comprising:
one or more memories storing processor-executable code; and
one or more processors coupled with the one or more memories and individually or collectively operable to execute the code to cause the network entity to:
output, to a user equipment (UE), a capability query requesting one or more UE capabilities associated with a set of candidate UE configurations;
obtain, in response to the capability query, a capability message indicating at least a subset of the one or more UE capabilities associated with the set of candidate UE configurations;
output a control message indicating configuration information associated with at least one candidate UE configuration from the set of candidate UE configurations; and
communicate with the UE in accordance with the configuration information.

11. The network entity of claim 10, wherein the one or more processors are individually or collectively further operable to execute the code to cause the network entity to:
obtain, in response to a second capability query output prior to the capability query, a second capability message indicating a capability of the UE to respond to the capability query, wherein obtaining the capability query is based at least in part on outputting the second capability message.

12. The network entity of claim 11, wherein the second capability message comprises an indication of a threshold duration associated with responding to the capability query.

13. The network entity of claim 11, wherein, to obtain the second capability message, the one or more processors are individually or collectively operable to execute the code to cause the network entity to:
obtain an indication of one or more second UE capabilities associated with a plurality of candidate UE configurations comprising at least the set of candidate UE configurations.

14. The network entity of claim 11, wherein the second capability message is obtained during an initial access procedure with the UE.

15. The network entity of claim 10, wherein each UE capability of the at least subset of the one or more UE capabilities is associated with performing one or more UE operations in accordance with a candidate UE configuration from the set of candidate UE configurations.

16. The network entity of claim 10, wherein the one or more processors are individually or collectively further operable to execute the code to cause the network entity to:
output a second capability query requesting one or more second UE capabilities associated with a second set of candidate UE configurations; and
obtain, in response to the second capability query, a second capability message indicating at least a subset of the one or more second UE capabilities associated with the second set of candidate UE configurations.

17. The network entity of claim 10, wherein each candidate UE configuration of the set of candidate UE configurations comprises an indication of one or more bands, one or more band combinations, one or more band of band combinations, one or more component carriers, one or more bandwidths, one or more parameters associated with multiple input multiple output communications, a threshold quantity of layers, or any combination thereof.

18. A method for wireless communications at a user equipment (UE), comprising:
receiving, from a network entity, a capability query requesting one or more UE capabilities associated with a set of candidate UE configurations;
transmitting, in response to the capability query, a capability message indicating at least a subset of the one or more UE capabilities associated with the set of candidate UE configurations;
receiving, from the network entity, a control message indicating configuration information associated with at least one candidate UE configuration from the set of candidate UE configurations; and
communicating with the network entity in accordance with the configuration information.

19. The method of claim 18, further comprising:
transmitting, in response to a second capability query received prior to the capability query, a second capability message indicating a capability of the UE to respond to the capability query, wherein receiving the capability query is based at least in part on transmitting the second capability message.

20. The method of claim 19, wherein the second capability message comprises an indication of a threshold duration associated with responding to the capability query.

21. The method of claim 19, wherein transmitting the second capability message comprises:
transmitting an indication of one or more second UE capabilities associated with a plurality of candidate UE configurations comprising at least the set of candidate UE configurations.

22. The method of claim 19, wherein the second capability message is transmitted during an initial access procedure with the network entity.

23. The method of claim 18, wherein each UE capability of the at least subset of the one or more UE capabilities is associated with performing one or more UE operations in accordance with a candidate UE configuration from the set of candidate UE configurations.

24. The method of claim 18, further comprising:
receiving a second capability query requesting one or more second UE capabilities associated with a second set of candidate UE configurations; and
transmitting, in response to the second capability query, a second capability message indicating at least a subset of the one or more second UE capabilities associated with the second set of candidate UE configurations.

25. The method of claim 18, wherein each candidate UE configuration of the set of candidate UE configurations comprises an indication of one or more bands, one or more band combinations, one or more band of band combinations, one or more component carriers, one or more bandwidths, one or more parameters associated with multiple input multiple output communications, a threshold quantity of layers, or any combination thereof.

26. The method of claim 18, further comprising:
inputting, into a machine learning model, the set of candidate UE configurations, wherein transmitting the capability message indicating the at least subset of the one or more UE capabilities is based at least in part on the machine learning model outputting the at least subset of the one or more UE capabilities.

27. A method for wireless communications at a network entity, comprising:
outputting, to a user equipment (UE), a capability query requesting one or more UE capabilities associated with a set of candidate UE configurations;
obtaining, in response to the capability query, a capability message indicating at least a subset of the one or more UE capabilities associated with the set of candidate UE configurations;
outputting a control message indicating configuration information associated with at least one candidate UE configuration from the set of candidate UE configurations; and
communicating with the UE in accordance with the configuration information.

28. The method of claim 27, further comprising:
obtaining, in response to a second capability query output prior to the capability query, a second capability message indicating a capability of the UE to respond to the capability query, wherein obtaining the capability query is based at least in part on outputting the second capability message.

29. The method of claim 27, further comprising:
outputting a second capability query requesting one or more second UE capabilities associated with a second set of candidate UE configurations; and
obtaining, in response to the second capability query, a second capability message indicating at least a subset of the one or more second UE capabilities associated with the second set of candidate UE configurations.

30. The method of claim 27, wherein each candidate UE configuration of the set of candidate UE configurations comprises an indication of one or more bands, one or more band combinations, one or more band of band combinations, one or more component carriers, one or more bandwidths, one or more parameters associated with multiple input multiple output communications, a threshold quantity of layers, or any combination thereof.
